(19) United States
(12) Patent Application Publication
(10) Pub. No.: US 2018/0122157 A1
(43) Pub. Date: May 3, 2018

(54) ACTIVITY RECORDER, ACTIVITY RECORDING PROGRAM, AND ACTIVITY RECORDING METHOD

(71) Applicant: MITSUBISHI ELECTRIC CORPORATION, Chiyoda-ku, Tokyo (JP)

(72) Inventors: Tsubasa TOMODA, Tokyo (JP); Tomohito NAKATA, Tokyo (JP); Tetsuya TAMAKI, Tokyo (JP)

(73) Assignee: MITSUBISHI ELECTRIC CORPORATION, Chiyoda-ku, Tokyo (JP)

(21) Appl. No.: 15/563,451

(22) PCT Filed: Mar. 17, 2016
(86) PCT No.: PCT/JP2016/058433

§ 371 Date: Sep. 29, 2017

(30) Foreign Application Priority Data
Jul. 22, 2015 (JP) 2015-144724

(51) Int. Cl. G07C 1/10; G06Q 10/06

(52) U.S. Cl. CPC G07C 1/10; G06Q 50/04; G06Q 10/063114

(57) ABSTRACT

This activity recorder for recording, as activity data, an activity of a worker, includes: a first specification unit for specifying the worker; a second specification unit for specifying a position of the worker; a third specification unit for specifying a target of the worker; a fourth specification unit for specifying a mode of the worker; and a recording unit for recording, as the activity data, the worker, the position, the target, and the mode, with a specified time as an activity time associated therewith, the worker, the position, the target, and the mode having been respectively specified by the first specification unit, the second specification unit, the third specification unit, and the fourth specification unit.

### TECHNICAL FIELD

The present invention relates to an activity recorder, an activity recording program, and an activity recording method which are for recording activities of workers in a region, such as a production site, where the workers perform activities, and which are, in particular, for recording overall activities of the workers in a simple manner.

### BACKGROUND ART

At a production site, production facilities (machines) and workers (persons) are present, and they have respective roles to perform production activities. Processing of materials, assembling of products, and the like are performed by workers in some cases, and are automatically performed by use of machines in other cases. Even in a case where machines automatically perform production activities, workers play important roles in the production site, such as when the workers supply materials, carry products, or confirm whether the operational states of the machines are normal. Therefore, to grasp how efficiently the workers perform production activities (hereinafter, worker activity) is important when the productivity of the entire production site is to be evaluated.

Conventionally, when the worker activity is to be recorded/analyzed, activities of workers are recorded and used in analysis by a so-called IE (Industrial Engineering) technique in which a third party observes the workers at the production site. For example, in a “video (VTR, videotape recorder) motion analysis” method, an observer continuously shoots and records the worker activity by use of video equipment, and the task sequence and each motion are analyzed (for example, see Non-Patent Document 1). In a “work sampling method”, the operation states, the kinds of jobs, and the like of persons and machines are instantaneously observed, and the time configuration and the like for each observation item is analyzed (for example, see Non-Patent Document 2).

However, these IE techniques have a problem that the observer is required to exert much effort in performing the observation, and that it is difficult to accurately record a large amount of worker activity, in a large amount, and in more detail. With respect to this problem, a task performance obtaining technology in which each worker inputs his/her own worker activity performance into a terminal (for example, see Patent Document 1), and a technology in which motions of each worker are automatically obtained by use of sensors and the like (for example, see Patent Document 2) have been developed.

### CITATION LIST

### Patent Document

Patent Document 1: Japanese Laid-Open Patent Publication No. 2005-b 250726

Patent Document 2: Japanese Laid-Open Patent Publication No. 2009-294732

### Non-patent Document

Non-Patent Document 1: HIRANO HIROYUKI, “Shin-sagyou kenkyuu -Gendai monozukuri no kihon gijutsu-(provisional translation: New task study -basic technology of contemporary manufacturing-)”, NIKKAN KOGYO SHIMBUN, LTD., issued on Jan. 15, 2004 (PP. 73 to 77)

Non-Patent Document 2: FUJITA AKIHISA, “Shinpan IE no kiso (provisional translation: New edition the basics of IE)”, KENPAKUSHA, issued on Sep. 1, 1999 (pp. 199 to 230)

### SUMMARY OF THE INVENTION

### Problems to be Solved by the Invention

However, unlike a machine, each worker does not necessarily continue performing determined motions at a place fixed in advance, and could sometimes move around a plant for carrying a product, or could sometimes be exhausted and suspend the work. Although there are technologies in which IE techniques are automated by use of sensors and by use of inputs into terminals as in Patent Documents 1, 2, such technologies have a problem that they cannot record the activities of the worker as described above, and cannot be considered to record the overall worker activity which is necessary in productivity analysis.

The present invention has been made in order to solve the above problems. An object of the present invention is to provide an activity recorder, an activity recording program, and an activity recording method that are capable of recording the overall activities of workers in a simple manner.

### Solution to the Problems

An activity recorder according to the present invention is

an activity recorder for recording, as activity data, an activity of a worker, the activity recorder including:

a first specification unit for specifying the worker;

a second specification unit for specifying a position of the worker;

a third specification unit for specifying a target of the worker;

a fourth specification unit for specifying a mode of the worker; and

a recording unit for recording, as the activity data, the worker, the position, the target, and the mode, with a specified time as an activity time associated therewith, the worker, the position, the target, and the mode having been respectively specified by the first specification unit, the second specification unit, the third specification unit, and the fourth specification unit.

An activity recording program according to the present invention is

an activity recording program for recording, as activity data, an activity of a worker, the activity recording program causing a computer to perform:

a first specification step of specifying a worker;

a second specification step of specifying a position of the worker;

a third specification step of specifying a target of the worker;

a fourth specification step of specifying a mode of the worker; and

a recording step of recording, as the activity data, the worker, the position, the target, and the mode, with a specified time as an activity time associated therewith, the worker, the position, the target, and the mode having been respectively specified in the first specification step, the second specification step, the third specification step, and the fourth specification step.

An activity recording method according to the present invention is

an activity recording method for recording as activity data, an activity of a worker, the activity recording method comprising:

a first specification step of specifying a worker;

a second specification step of specifying a position of the worker;

a third specification step of specifying a target of the worker;

a fourth specification step of specifying a mode of the worker; and

a recording step of recording, as the activity data, the worker, the position, the target, and the mode, with a specified time as an activity time associated therewith, the worker, the position, the target, and the mode having been respectively specified in the first specification step, the second specification step, the third specification step, and the fourth specification step.

### Effect of the Invention

According to the activity recorder, the activity recording program, and the activity recording method of the present invention, overall activities of workers can be recorded in a simple manner.

### BRIEF DESCRIPTION OF THE DRAWINGS

FIG. 1 shows a configuration of hardware of an activity recorder according to embodiment 1 of the present invention.

FIG. 2 is a functional configuration diagram of the activity recorder according to embodiment 1 of the present invention.

FIG. 3 is a flow chart for recording activity data in the activity recorder according to embodiment 1 of the present invention.

FIG. 4 shows an example of a record of activity data in embodiment 1.

FIG. 5 is a functional configuration diagram of an activity recorder according to embodiment 2 of the present invention.

FIG. 6 shows a relationship database in embodiment 2.

FIG. 7 shows one example of a display screen of a display of the activity recorder in embodiment 2.

FIG. 8 is a flow chart showing a process performed by a first specification unit using a worker ID list in embodiment 2.

FIG. 9 is a flow chart showing a process performed by a second specification unit using a position list in embodiment 2.

FIG. 10 is a flow chart showing a process performed by a third specification unit using a target list in embodiment 2.

FIG. 11 is a flow chart showing a process performed by a fourth specification unit using a mode list in embodiment 2.

FIG. 12 is a flow chart showing a process performed by an activity recorder in embodiment 3.

FIG. 13 is a flow chart showing another process performed by the activity recorder in embodiment 3.

FIG. 14 is a flow chart showing another process performed by the activity recorder in embodiment 3.

FIG. 15 shows a relationship database in embodiment 4.

FIG. 16 is a diagram describing how the position and the target are narrowed by use of internal variables in the relationship database in embodiment 4.

FIG. 17 shows the relationship between the internal variable and the screen display on the display in the relationship database in embodiment 4.

FIG. 18 shows an example of the screen display on the display in embodiment 5.

FIG. 19 shows a screen display on the display during task suspension in embodiment 5.

FIG. 20 is a flow chart showing operation of an activity recorder in embodiment 5.

FIG. 21 is a flow chart showing operation of the activity recorder in embodiment 5.

FIG. 22 is a flow chart showing operation of the activity recorder in embodiment 5.

FIG. 23 shows an example of a record of activity data in embodiment 5.

FIG. 24 is a flow chart showing a process performed by the first specification unit using an IC card in embodiment 6.

FIG. 25 is a flow chart showing a process performed by the first specification unit using a face recognition camera in embodiment 7.

FIG. 26 is a flow chart performed by the first specification unit using a fingerprint recognition sensor in embodiment 8.

FIG. 27 is a flow chart showing a process performed by a second specification unit using a GPS sensor in embodiment 9.

FIG. 28 is a data table used by the second specification unit in embodiment 9.

FIG. 29 is a flow chart showing a process performed by the second specification unit using a radio field intensity sensor in embodiment 10.

FIG. 30 shows characteristics of radio field intensity vs distance of a beacon used by the second specification unit in embodiment 10.

FIG. 31 shows an example of time series change in radio field intensity of a beacon used by the second specification unit in embodiment 10.

FIG. 32 is a data table used by the second specification unit in embodiment 10.

FIG. 33 is a flow chart showing a process performed by the third specification unit using information from a production facility in embodiment 11.

FIG. 34 is a flow chart showing a process performed by the fourth specification unit using a motion capture apparatus in embodiment 12.

FIG. 35 is a diagram describing how a walking state and a stopped state are detected on the basis of the cumulative number of steps and the elapsed time period by the fourth specification unit using an acceleration sensor in embodiment 12.

FIG. 36 is a flow chart showing a process performed by the fourth specification unit using an acceleration sensor in embodiment 13.

FIG. 37 is a flow chart showing a process performed by the second specification unit using an acceleration sensor and a terrestrial magnetism sensor in embodiment 14.

FIG. 38 shows an example of a communication configuration and arrangement of the activity recorder provided with a communication module according to embodiment 15.

### DESCRIPTION OF EMBODIMENTS

### Embodiment 1

The present invention presents an activity recorder that can easily record activity data of a worker by defining in advance the occurrence pattern of worker activity and the kind of information to be obtained that are necessary in productivity analysis of the worker in a region, such as a production site, where the worker performs an activity.

The data of a record of an activity of a worker in the present invention (hereinafter, referred to as “activity data”) is a set of data composed of five elements: “worker”; “position of the worker” (hereinafter, referred to as “position”); “target of the worker” (hereinafter, referred to as “target”); “mode of the worker” (hereinafter, referred to as “mode”); and “time at which the worker performed an activity” (hereinafter, referred to as “activity time”).

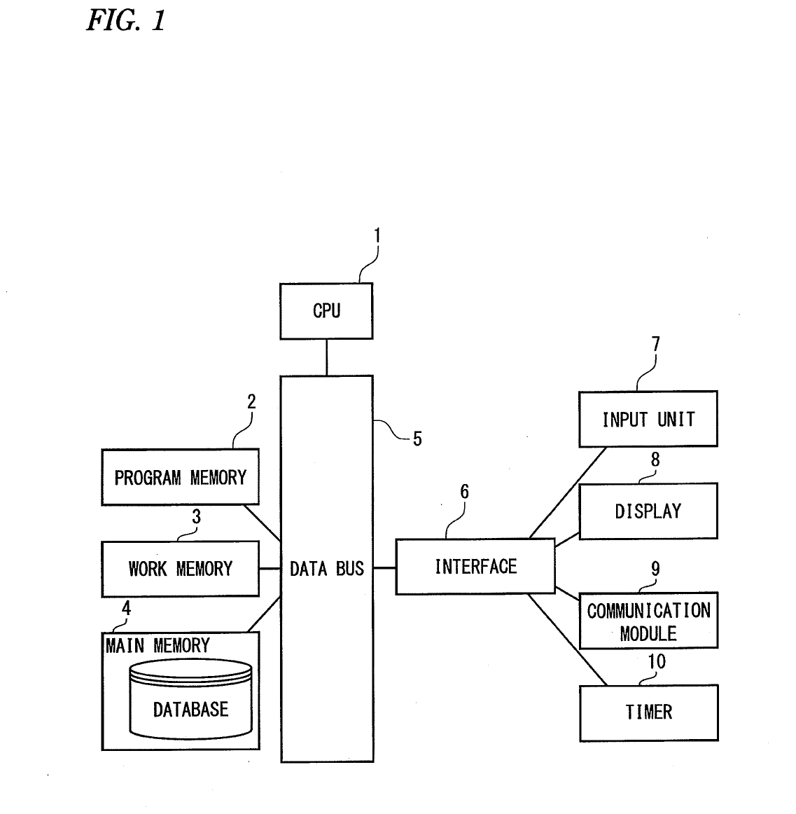

FIG. 1 shows a configuration of hardware of an activity recorder in embodiment 1 of the present invention. It should be noted that FIG. 1 shows the configuration of hardware, of the activity recorder, that is common in all embodiments described below. In the drawing, in the activity recorder according to embodiment 1 of the present invention, a CPU (central processing unit) 1, a program memory 2 in which tasks to be executed by the CPU 1 are stored, a work memory 3 into which the CPU temporarily transfers data for performing processing, a main memory 4 (including a storage in which various databases and activity data are stored), an interface 6, and the like are connected to a data bus 5.

In the program memory 2, an activity recording program is stored which includes: a first specification step of specifying a worker; a second specification step of specifying a position of the worker; a third specification step of specifying an activity target of the worker; a fourth specification step of specifying an activity mode of the worker; and a recording step of recording, as activity data, the worker, the position, the target, and the mode, with a specified time as the activity time associated therewith, the worker, the position, the target, and the mode having been respectively specified in the first specification step, the second specification step, the third specification step, and the fourth specification step.

Further, an input unit 7 implemented by a touch panel, a display 8, and a timer 10 for managing time are connected via the interface 6. The timer 10 is also used as a time addition unit for adding the time. According to need, a communication module 9 for performing communication with the outside is connected. The display screen of the display 8 may also function as a touch panel and a keyboard.

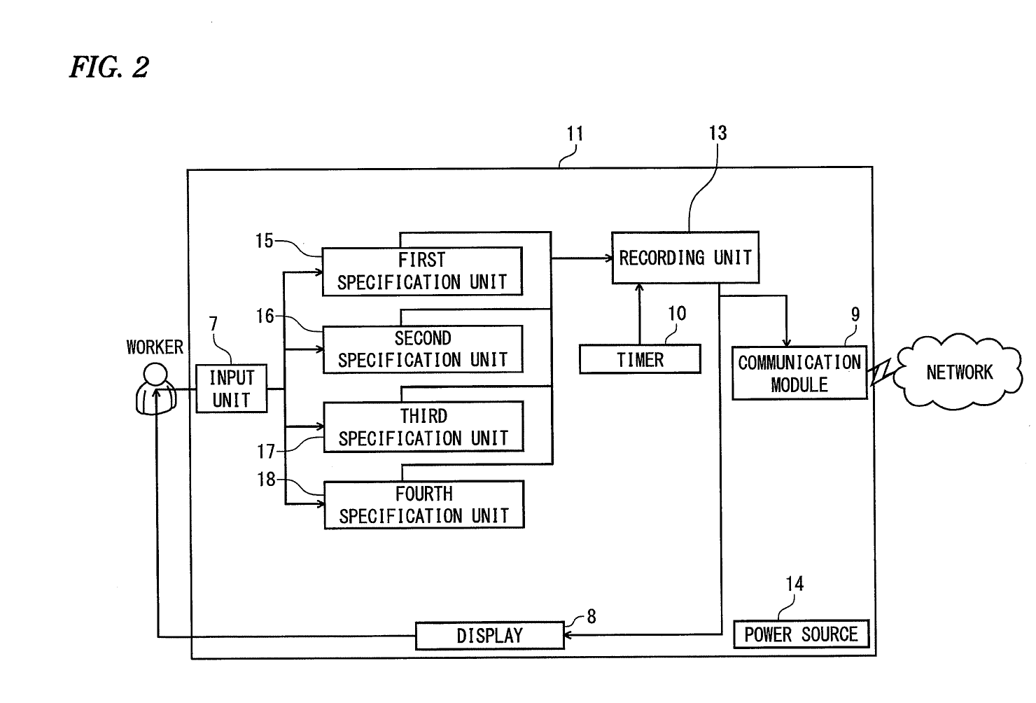

FIG. 2 is a functional configuration diagram of the activity recorder in embodiment 1 of the present invention.

An activity recorder 11 includes a first specification unit 15, a second specification unit 16, a third specification unit 17, a fourth specification unit 18, a recording unit 13, the input unit 7, the timer 10, the communication module 9, the display 8, and a power source 14.

In the present embodiment, each of the first specification unit 15, the second specification unit 16, the third specification unit 17, and the fourth specification unit 18 receives, from a worker through a touch panel of the input unit 7, data for specifying each element of the activity data. The first specification unit 15 specifies the worker. The second specification unit 16 specifies the position of the worker. The third specification unit 17 specifies the target of the worker. The fourth specification unit 18 specifies the mode of the worker.

The recording unit 13 records, as the activity data, the worker, the position, the target, and the mode, with a specified time from the timer 10 added as the activity time so as to be associated therewith, the worker, the position, the target, and the mode having been respectively specified by the first specification unit 15, the second specification unit 16, the third specification unit 17, and the fourth specification unit 18.

Then, the recording unit 13 stores the activity data of the worker in the storage included in the main memory 4. The activity data stored in the storage can be analyzed after being recorded, if the activity data is loaded on an external PC (personal computer) or the like.

According to need, the content of the activity data can be communicated with an external device through a network, by connecting the communication module 9 to the recording unit 13. The activity data sent to the display 8 connected to the recording unit 13 is utilized when task performance data is presented to the worker.

The activity recorder 11 has an independent power source 14 therein. Thus, the activity recorder 11 is not fixed to a place, but is of a portable type that can be carried by a worker. Therefore, no matter where the worker is and no matter what the worker is doing, the activity can always be continuously recorded.

In the present embodiment, a touch panel is used as the input unit 7 for the first specification unit 15. Other than this, an IC card reader, a face recognition camera, a fingerprint recognition sensor, or the like can also be used as the input unit 7 as necessary. These will be described in other embodiments.

In the present embodiment, a touch panel is used as the input unit 7 for the second specification unit 16. Other than this, a GPS sensor, a radio field intensity sensor, an acceleration sensor, a terrestrial magnetism sensor, or the like can also be used as the input unit 7 as necessary. These will be described in other embodiments.

In the present embodiment, a touch panel is used as the input unit 7 for the third specification unit 17. Other than this, a sensor that operates in association with a production facility can be used as the input unit 7 as necessary. This will be described in other embodiments.

In the present embodiment, a touch panel is used as the input unit 7 for the fourth specification unit 18. Other than this, a motion capture apparatus, an acceleration sensor, or the like can also be used as the input unit 7 as necessary. This will be described in other embodiments.

In the present embodiment, an example has been shown in which information is inputted through the input unit 7 which is used in common among the first specification unit 15, the second specification unit 16, the third specification unit 17, and the fourth specification unit 18. However, the present invention is not limited thereto. Each of the specification units 15, 16, 17, 18 may be provided with an input unit.

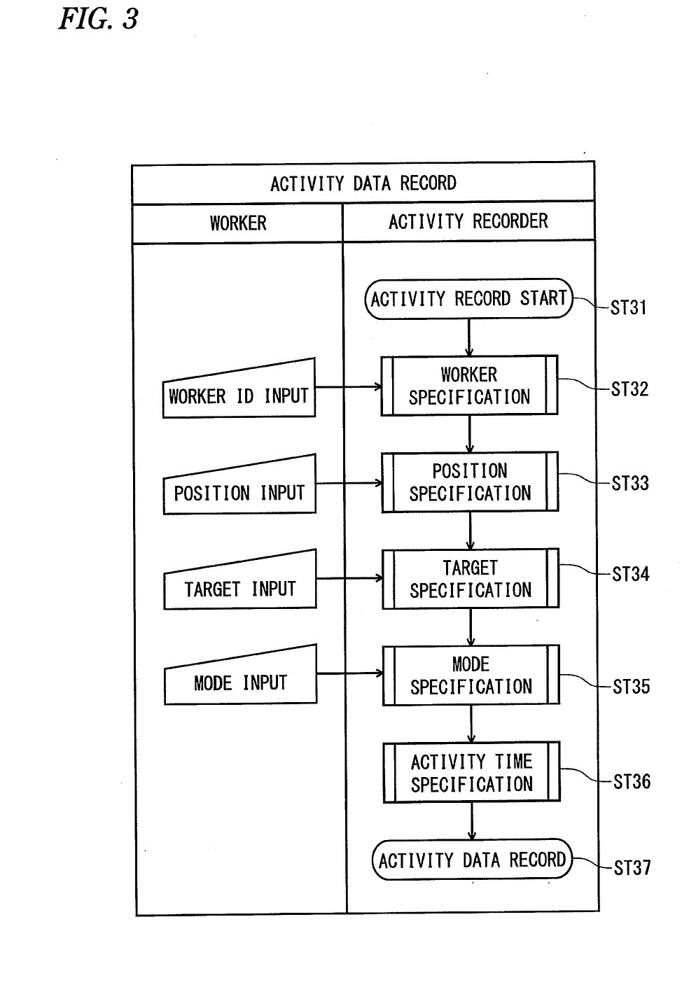

Next, a flow chart for obtaining each element for recording activity data for the activity recorder in the present embodiment 1 is described with reference to FIG. 3. It should be noted that the processes described below are performed by the respective functional components shown in FIG. 2 executing the activity recording program stored in the program memory 2.

First, the worker to be observed is determined. In embodiment 1 of the present invention, each worker is caused to individually carry the activity recorder 11, whereby the worker is specified. In the present embodiment, the worker performs a first specification step of specifying a worker by directly inputting, through the input unit 7, an ID (abbreviation of identification) of the worker to the first specification unit 15 of the activity recorder 11 of the present embodiment 1 (step ST32 in FIG. 3).

Next, the position of the worker is determined, such as, for example, whether the worker is in a warehouse, whether the worker is at an assembly line, or the like. In the present embodiment, the worker performs a second specification step of specifying a position by directly inputting, through the input unit 7, information of the position of the worker to the second specification unit 16 of the activity recorder 11 (step ST33 in FIG. 3).

Next, the target at the position of the worker is determined. For example, a target such as “model A” or “manufacturing lot B” is selected. In the present embodiment, the worker performs a third specification step of specifying a target by directly inputting, through the input unit 7, information of the target to the third specification unit 17 of the activity recorder 11 (step ST34 in FIG. 3).

Next, the mode with respect to the target is determined. In the present embodiment, the worker performs a fourth specification step of specifying a mode by directly inputting, through the input unit 7, information of the mode to the fourth specification unit 18 of the activity recorder 11 (step ST35 in FIG. 3).

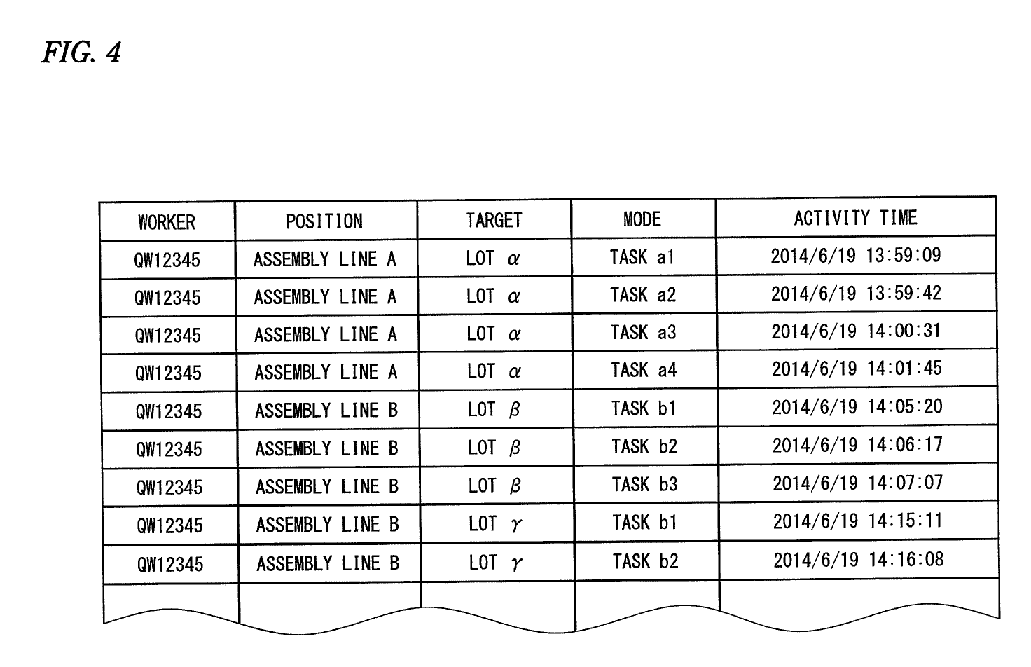

Lastly, the time at which the mode was determined, i.e., the time at which all the elements were determined, is obtained from the timer 10 and added so as to be associated, and is specified as the activity time (step ST36 in FIG. 3). At this time point, all the elements of the activity data of the worker are determined. The recording unit 13 performs a recording step of recording, in the storage of the main memory 4, the activity data as shown in FIG. 4, for example (step ST37 in FIG. 3). Step ST31 to step ST37 shown in the column of the activity recorder 11 in FIG. 3 represent the processing flow as an activity recording method that is executed in common among other embodiments.

As shown in FIG. 4, each column indicates an element of the activity data, and each row indicates activity data of one case. In FIG. 4, in the first column, worker information is included and the worker ID is recorded. In the second column, the position is written. In the third column, the target is written. A manufacturing lot is recorded, on the assumption that the worker at a manufacturing line works on a workpiece being conveyed along the manufacturing line. In the fourth column, the mode is written.

The activity data is recorded for each case, every time the mode changes. In the fifth column, the activity time is recorded. The activity time is defined as the time at which the mode changed. Through the recording of the activity data in this format, the history of the activity of each worker in a plant can be recorded.

Next, the significance of creating the activity data as a set of five elements of “worker”, “position”, “target”, “mode”, and “activity time” in the present embodiment 1 is described.

In general, as a first characteristic of production activity performed at a production site, an unspecified large number of people do not engage in the production activity. A production site is characterized by specific people engaging in the production activity according to an employment contract. This means that “who” i.e., the people, needs to be specified.

As a second characteristic, at a production site, a task of providing an added value to a product, such as processing of a material, assembling of a product, or the like, is performed. In addition, at a production site, a task that does not provide an added value, such as carrying a product, monitoring the operational state of a machine, or the like, is performed. Thus, these two kinds of tasks exist at a production site. The task of providing an added value is characterized by being performed at a place determined in advance in the production site.

This means that if “where” is specified, the task that should be performed can be narrowed in a restricting manner. For example, when the place is “warehouse”, the place is where articles are stored. Thus, the production activity that is performed at “warehouse” is any one of carrying-in of articles, carrying-out of articles, and several kinds of tasks that occur associated therewith.

As a third characteristic, at a production site, the main target of the production activity, i.e., “what”, always exists such as: the kind of a material or a product; which manufacturing lot of the same kind of product; or which of individual workpieces from the same manufacturing lot. In this manner, each production activity is performed on a specific target.

In a case where the activity data is to be analyzed with respect to the above specified three characteristics, i.e., “who”, “where”, and “what”, it is further necessary to specify “in what mode”. For example, it is necessary to specify the mode of the activity performed by the worker, such as “mode in which the worker has set a workpiece to a machine”, “mode in which the worker has completed processing of a workpiece”, or “mode in which the worker has held and started carrying a workpiece”.

Lastly, “when” as the timing at which “who” does “what” in “where” “in what mode” is specified. Then, the activity data of the worker is analyzed in time series. Accordingly, it becomes possible to obtain information for evaluating the efficiency of individual workers and the productivity of the entire production site.

Therefore, the activity recorder 11 in embodiment 1 of the present invention has the activity data of the worker in which at least five elements of “worker”, “position”, “target”, “mode”, and “activity time” are specified and used as a set. Then, every time any one of “worker”, “position”, “target”, and “mode” has changed, the recording unit 13 records, as the activity data, “worker”, “position”, “target”, and “mode”, together with the activity time.

Up to now, apparatuses for recording activities of workers in a plant have been proposed. However, since elements of activity data that are necessary and sufficient in productivity analysis are not specified, excess or shortage of the amount of data collected for the analysis is caused. This poses a problem that a large man-hour is required in extracting significant information from data.

In the present embodiment 1, data using “worker”, “position”, “target”, “mode”, and “activity time” as a set is defined as activity data, and this is recorded at each change point of the worker, the position, the target, or the mode, thereby allowing recording of the activity data that is necessary and sufficient for productivity analysis. In addition, by causing each worker to carry one activity recorder 11 which has a mechanism of recognizing the above five elements of the activity data, it becomes possible to always continuously record the activity of the worker no matter where the worker is and no matter what the worker is doing.

According to the activity recorder of embodiment 1 configured as above, the worker, the position, the target, and the mode, with a specified time as the activity time associated therewith, are recorded as the activity data. Thus, the history of activities of each individual worker in a productivity analysis can be recorded in a necessary and sufficient manner, and the man-hour for the productivity analysis can be reduced.

In addition, the activity data necessary for productivity analysis by a video motion analysis method, a work sampling method, and the like that use IE techniques can be accurately obtained in an electronic form, in a simple manner, in detail, and in a large amount. In addition, since the activity recorder can be carried by each individual worker, productivity analysis of a worker who moves among places, which has been conventionally difficult, is facilitated.

Every time at least one of elements of the worker, the position, the target, and the mode that have been specified changes, the worker, the position, the target, and the mode, with a specified time added as the activity time, are recorded as the activity data. Thus, task data recording excellent in accuracy can be performed.

### Embodiment 2

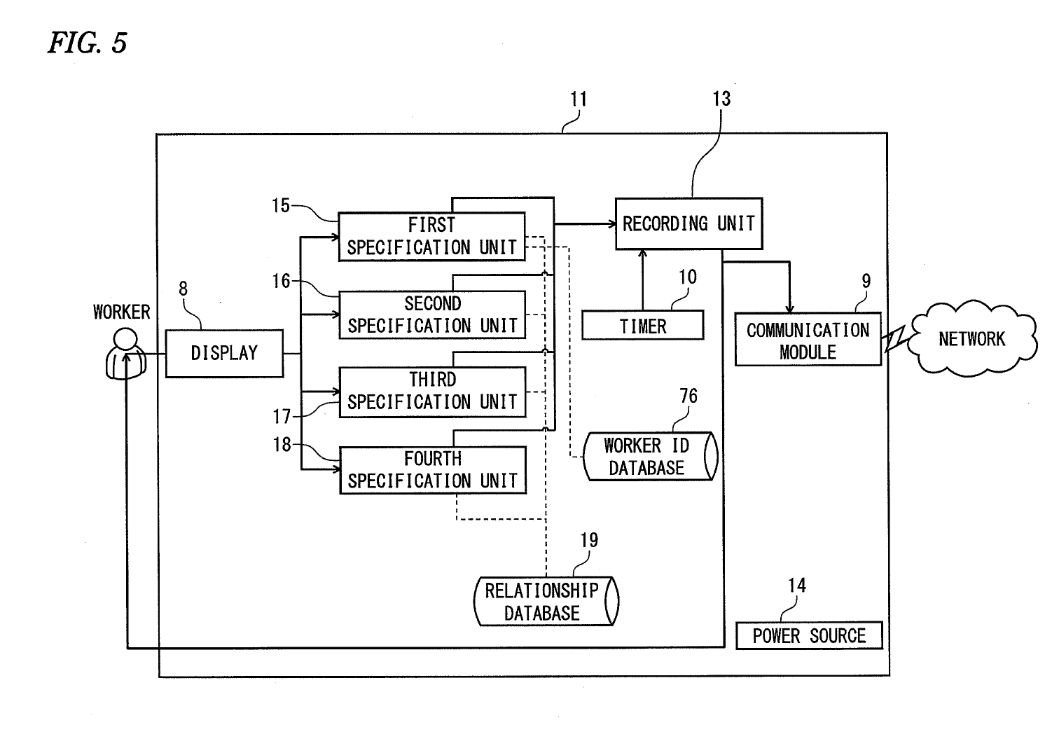

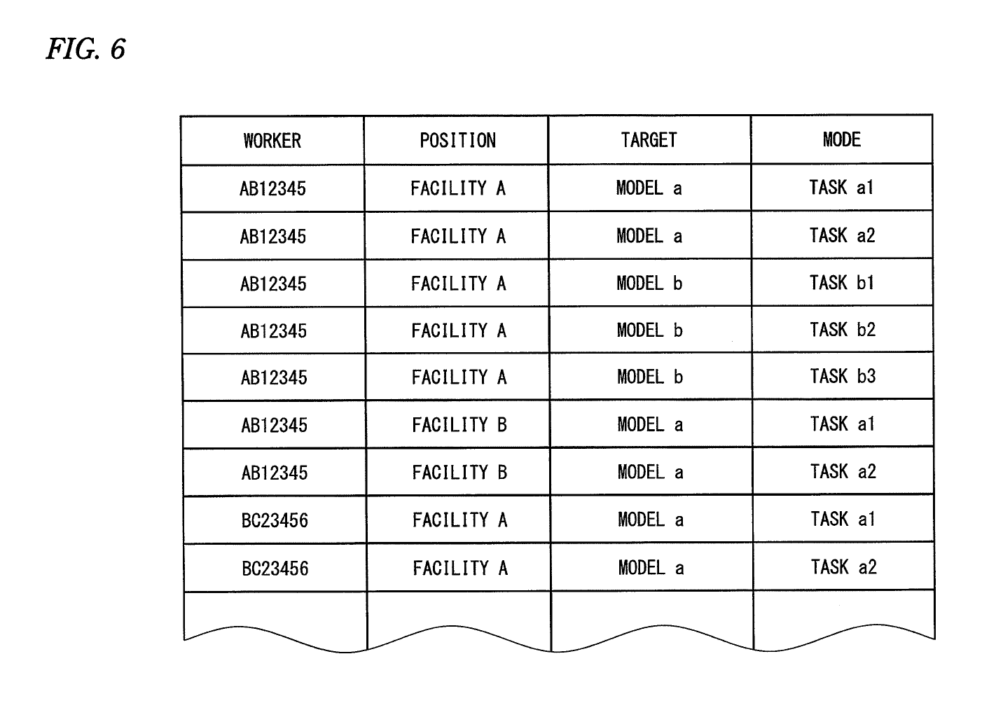

FIG. 5 shows a configuration of the activity recorder 11 in embodiment 2 of the present invention. FIG. 6 shows a configuration of a relationship database of the activity recorder 11 shown in FIG. 5. In embodiment 1 above, an example has been described in which each element is specified by a corresponding specification unit. However, in the present embodiment, a case is described in which a relationship database (hereinafter, database is abbreviated as DB) 19 in which “worker”, “position”, “target”, and “mode” as the elements are associated with one another in advance is used.

In the drawings, parts that are the same as those in embodiment 1 above are denoted by the same reference characters, and description thereof is omitted. In FIG. 5, specification units 15, 16, 17, 18 are connected to the relationship database 19. Each specification unit 15, 16, 17, 18 checks the received data against the relationship DB 19, and specifies a corresponding element of the activity data.

As shown in FIG. 6, the relationship DB 19 is a collection of data composed of four dimensions of worker, position, target, and mode. Individual data expresses one mode. That is, the relationship DB 19 is a DB of mode, and search in the DB is performed in order to narrow the mode.

In specifying the activity data, a set of the worker, the position, and the target, which are items at a higher order than the mode, is specified first. For example, as shown in FIG. 6, when the worker is specified as AB12345, the position is facility A or facility B. Subsequently, when the position is specified as facility A, the target is model a or model b. When model b is selected, a set of corresponding modes {task b1, task b2, task b3} is obtained.

Thus, the relationship DB 19 can be realized by adding a mode to each of all possible combinations of worker, position, and target.

In addition, a worker ID DB 76 is connected to the first specification unit 15. The worker ID DB 76 has stored worker IDs therein. However, the worker ID DB 76 can be formed by extracting information of each worker ID from the relationship DB 19.

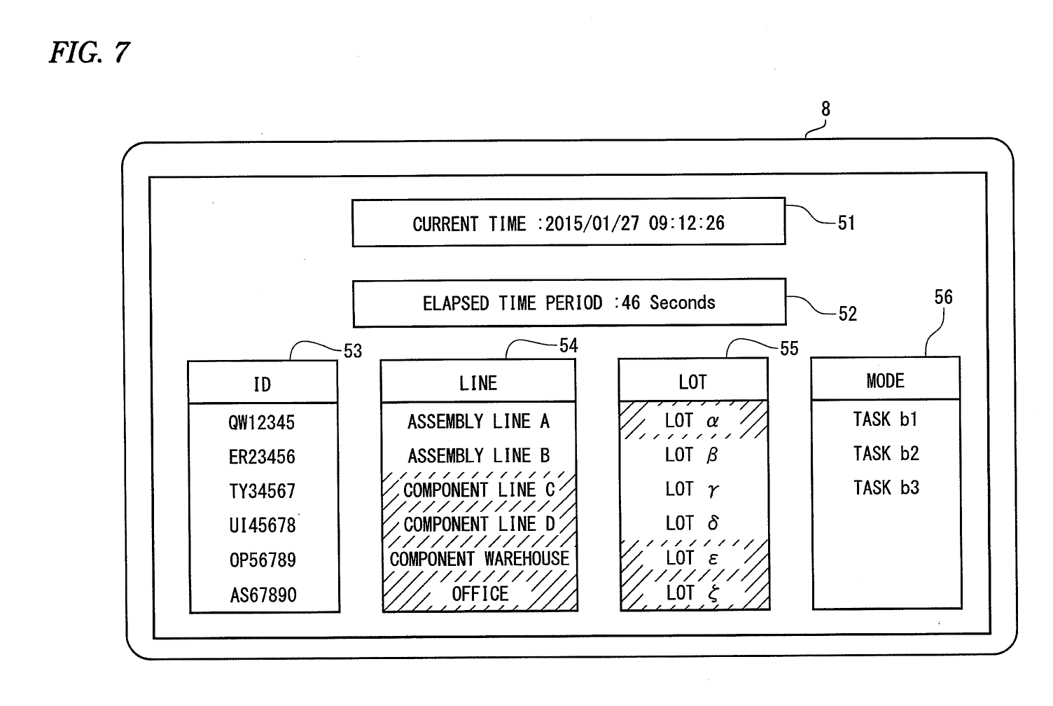

FIG. 7 shows an example of a case where, with respect to the first specification unit 15, the second specification unit 16, the third specification unit 17, and the fourth specification unit 18, a worker performs selection and inputting on a list displayed on the touch panel screen of the display 8 according to the present embodiment. Thus, in the present embodiment 2, the display 8 also serves as the input unit 7 shown in embodiment 1 above.

A worker list 53, a position list 54, a target list 55, and a mode list 56 are displayed on the screen of the display 8 of the activity recorder 11. However, the names of the lists on the display screen are indicated as ID, line, and lot so as to be easily understood. In addition, a first display part 51 for displaying the current time and a second display part 52 for displaying the elapsed time period are present.

The worker selects a corresponding worker, a corresponding position, and a corresponding target, one by one, first. Every time one element is selected, necessary options become able to be selected on the list as a result of narrowing on the basis of the relationship DB 19 shown in FIG. 4. At the time point when all the elements of the worker, the position, and the target have been specified, a corresponding mode list is loaded from the relationship DB 19 and is displayed on the display 8. At the time point when a mode has been specified, activity data including the current time is saved in the storage, and a timer for counting an elapsed time period is started.

At the time point the mode changes after the task has ended, the worker selects, from the mode list, a mode that the worker is going to engage in next. Then, activity data including, as the activity time, the current time being displayed in the first display part 51 is saved in the storage. At the same time, the elapsed time period in the second display part 52 is reset, and counting of an elapsed time period regarding the next task is started.

Next, a specific example of each specification unit 15, 16, 17, 18 of the activity recorder of embodiment 2 configured as above and their processes are described.

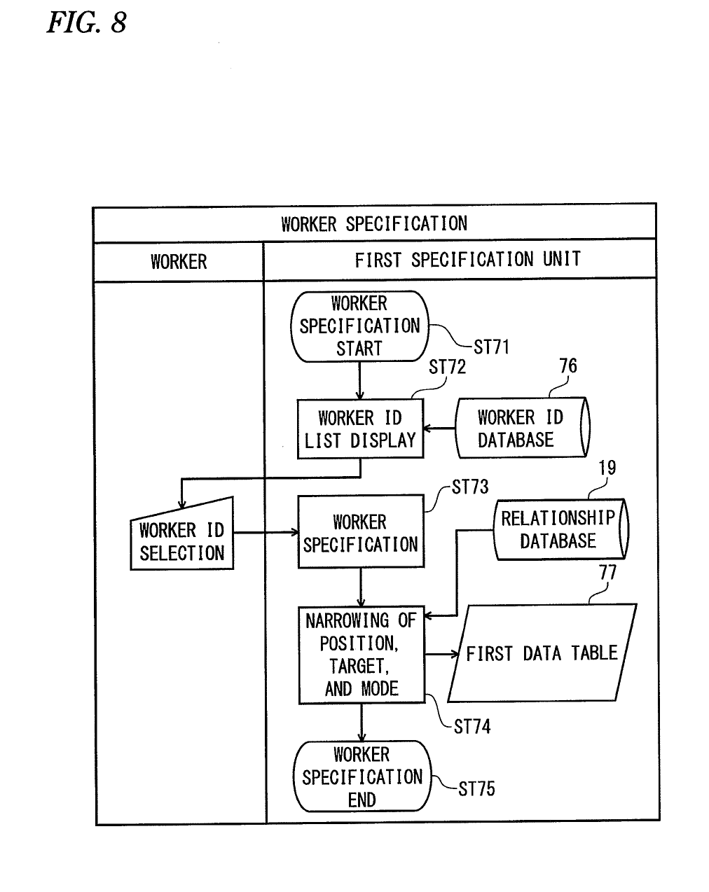

FIG. 8 shows a process in which a selection is made from a worker ID list, as a process that corresponds to the first specification unit 15. A worker specifying process is started (step ST71 in FIG. 8). The first specification unit 15 displays on the display 8 a worker ID list that is obtained from the worker ID DB 76 and that is to be presented to the worker (step ST72 in FIG. 8, the worker list 53 in FIG. 7). In response to this, the worker selects a worker ID that corresponds to the worker himself/herself, and inputs the selected worker ID into the first specification unit 15 through the display 8 which is a touch panel, whereby the worker is specified (step ST73 in FIG. 8).

In accordance with the specified worker, the first specification unit 15 narrows the corresponding position, target, and mode on the basis of the relationship DB 19 to extract corresponding relationship data, and creates a first data table 77 (step ST74 in FIG. 8). After the above process, the worker specifying process ends (step ST75 in FIG. 8).

According to the present embodiment, worker inputting only through a general-purpose input interface such as a touch panel or a keyboard can be realized.

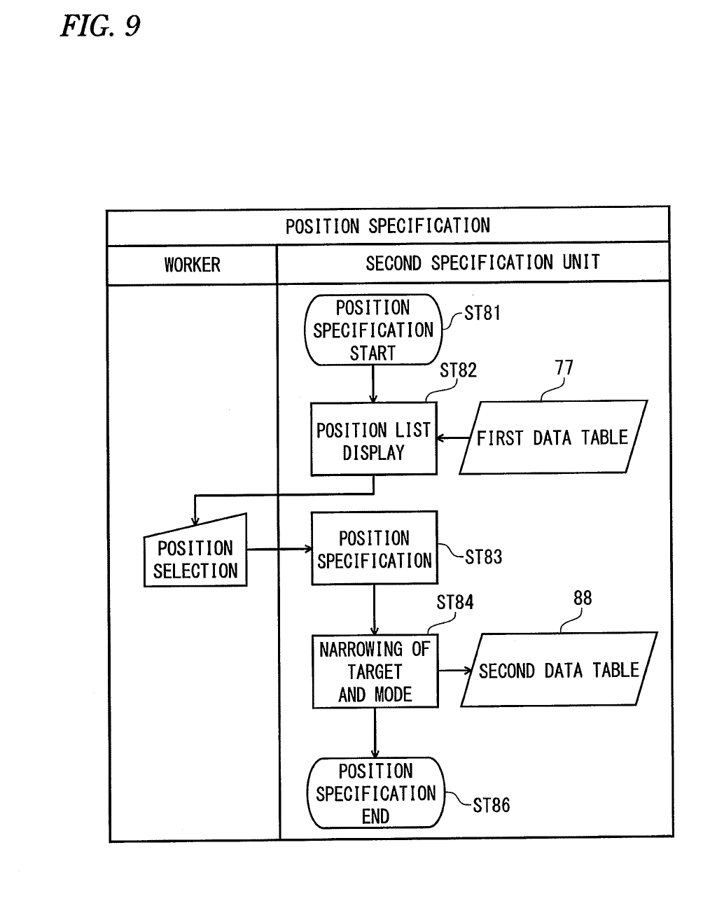

FIG. 9 shows a process in which a selection is made from a list of positions, as a process that corresponds to the second specification unit 16. A position specifying process is started (step ST81 in FIG. 9). The second specification unit 16 displays on the display 8 a list of positions obtained from the first data table 77 created in the worker specifying process, the list of positions indicating positions at which the worker can perform activities (step ST82 in FIG. 9, the portion not provided with hatching in the position list 54 in FIG. 7). In response to this, the worker selects a position that corresponds to the worker himself/herself, and inputs the selected position into the second specification unit 16 through the display 8 which is a touch panel, whereby the position is specified (step ST83 in FIG. 9).

In accordance with the specified position, the second specification unit 16 narrows the corresponding target and mode on the basis of the first data table 77, and creates a second data table 85 (step ST84 in FIG. 9). After the above process, the position specifying process ends (step ST86 in FIG. 9).

According to the present embodiment, position inputting only through a general-purpose input interface such as a touch panel or a keyboard can be realized.

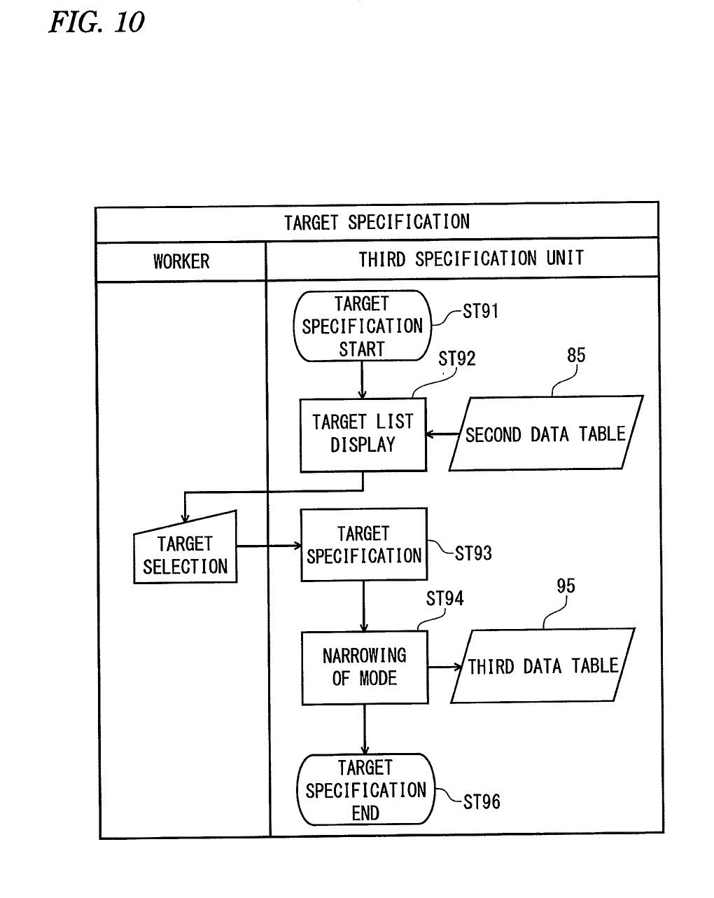

FIG. 10 shows a processing flow in which a selection is made from a list of targets, as a process that corresponds to the third specification unit 17.

A target specifying process is started (step ST91 in FIG. 10). The third specification unit 17 displays on the display 8 a list of targets obtained from the second data table 85 created through the worker specifying process and the position specifying process, the list of targets indicating targets on which the worker can perform activities at the position (step ST92 in FIG. 10, the portion not provided with hatching in the target list in FIG. 7). In response to this, the worker selects a target that corresponds to the worker himself/herself, and inputs the selected target into the third specification unit 17 through the display 8 which is a touch panel, whereby the target is specified (step ST93 in FIG. 10).

In accordance with the specified target, the third specification unit 17 narrows the corresponding mode on the basis of the second data table 85, and creates a third data table 95 (step ST94 in FIG. 10). After the above process, the target specifying process ends (step ST96 in FIG. 10).

According to the present embodiment, target inputting only through a general-purpose input interface such as a touch panel or a keyboard can be realized.

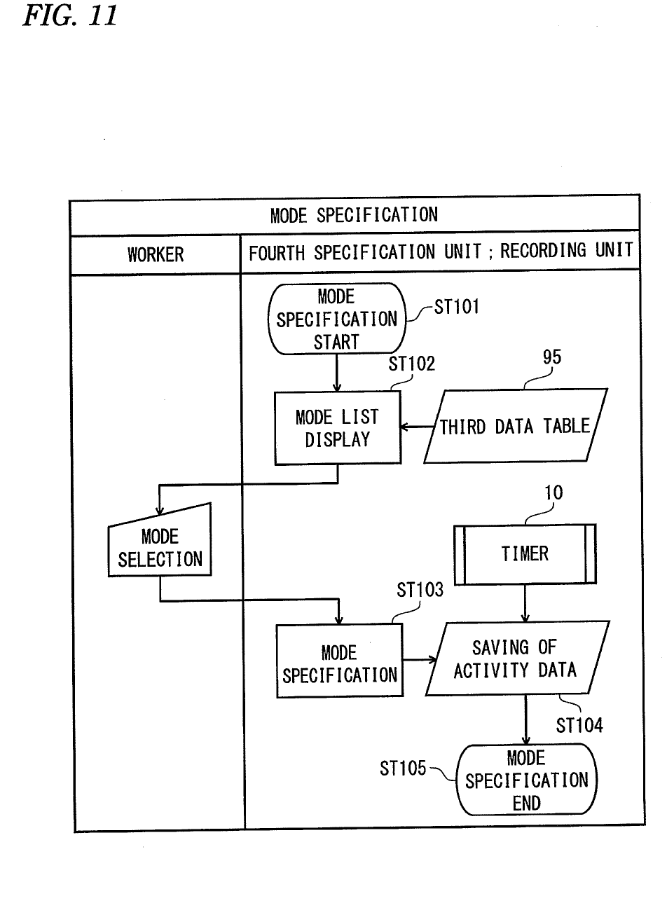

FIG. 11 shows a processing flow in which a selection is made from a list of modes, as a process that corresponds to the fourth specification unit 18.

When a mode specifying process is started (step ST101 in FIG. 11), the fourth specification unit 18 displays a list of modes for the target of the worker at the position, the list of modes obtained from the third data table 95 created through the worker specifying process, the position specifying process, and the target specifying process (step ST102 in FIG. 11, the mode list 56 in FIG. 7). In response to this, the worker selects a mode that corresponds to the worker himself/herself, inputs the selected mode into the fourth specification unit 18 through the display 8 which is a touch panel, whereby the mode is specified (step ST103 in FIG. 11).

The recording unit 13 saves, into the storage, the activity data composed of: the specified mode and the worker, position, and target that have been specified; and the activity time obtained from the timer 10 added thereto (step ST104 in FIG. 11). After the above process, the mode specifying process ends (step ST105 in FIG. 11).

According to the present embodiment, mode inputting only through a general-purpose input interface such as a touch panel or a keyboard can be realized.

It is needless to say that the activity recorder of embodiment 2 configured as above exhibits similar effects to those of embodiment 1 above. In addition, the activity recorder of embodiment 2 is provided with the relationship DB. Thus, in a case of a production activity that is performed at a production site, if “who” targets “what” in “where” can be specified, the mode of this activity data can be narrowed to some extent in terms of the occurrence pattern thereof.

### Embodiment 3

In the present embodiment 3, recording of the activity data is described in which, after the worker, the position, the target, and the mode have been specified in embodiment 2 above, only the mode changes, with the worker, the position, and the target unchanged.

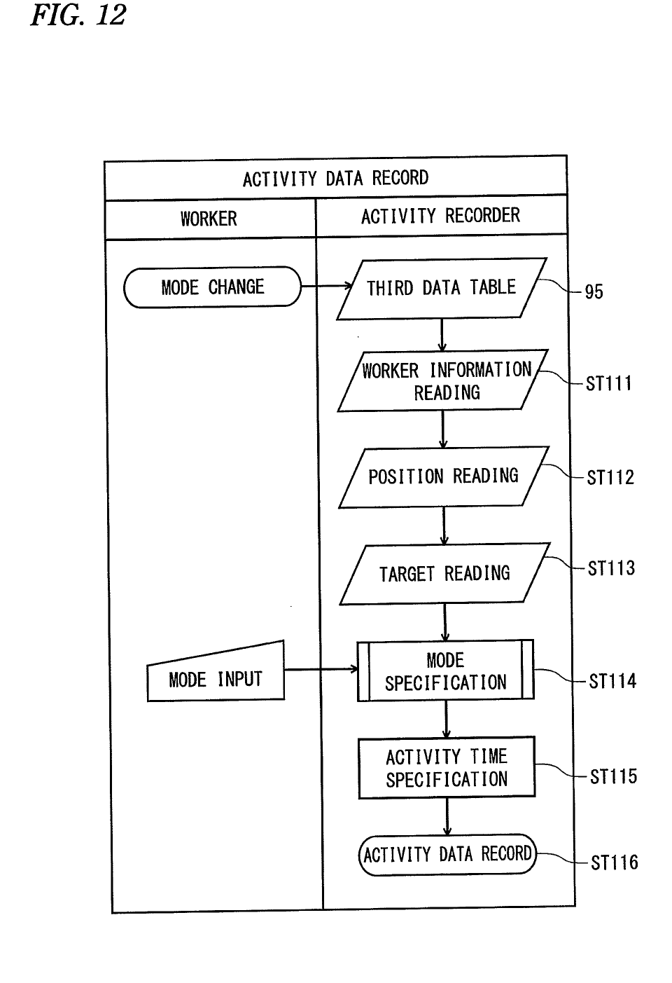

FIG. 12 is a flow chart showing operation of the activity recorder 11 in embodiment 3 of the present invention. When the worker has changed the mode, the fourth specification unit 18 reads out the worker information, the position, and the target from the third data table 95 created through the worker specifying process, the position specifying process, and the target specifying process (step ST111 to step ST113 in FIG. 12). Next, a list of modes is displayed similarly to embodiment 2 above. The worker selects one mode from the list, whereby the mode is specified (step ST114 in FIG. 12).

Next, similarly to embodiment 2 above, with respect to the specified mode, and the worker, the position and the target that have been specified in advance and read out, the recording unit 13 specifies the activity time obtained from the timer 10 (step ST115 in FIG. 12). Then, these are saved as the activity data in the storage (step ST116 in FIG. 12).

In the present embodiment, it is sufficient to record the activity data every time the mode has been changed. This is because the same mode is maintained between motions of the worker, and thus, there is no need to record the activity data in the period between these motions. Accordingly, worker activity recording that is sufficient for productivity analysis can be efficiently performed.

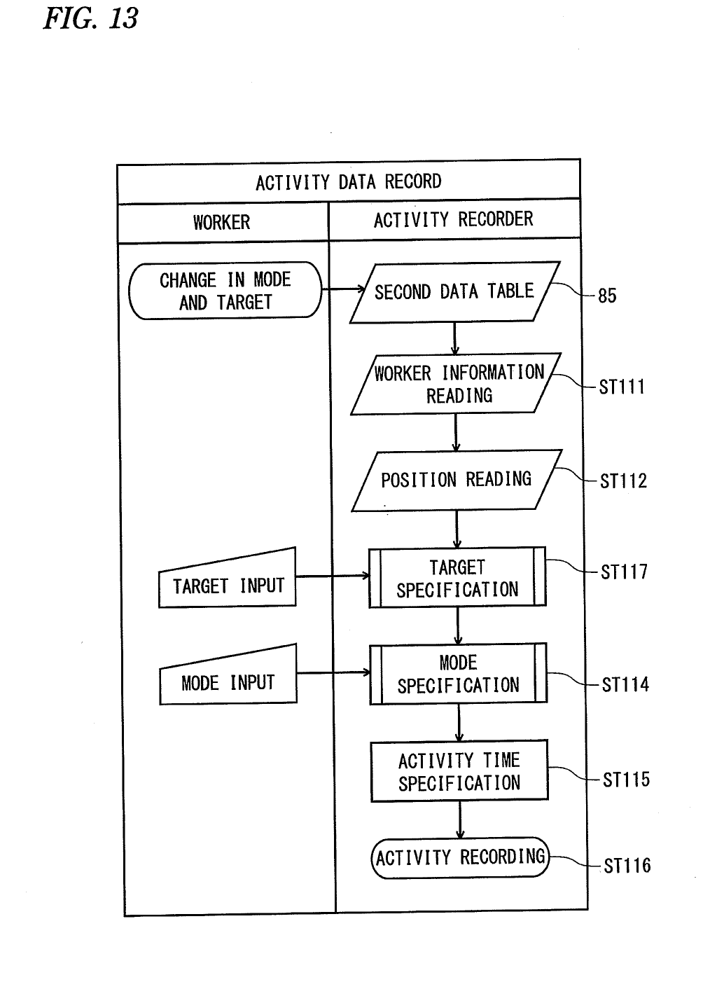

In embodiment 3 above, a case in which the worker, the position, the target are unchanged and only the mode is changed has been described. However, as another example, in a case where the worker and the position are unchanged and the target and the mode are changed, a process similar to that in embodiment 3 above can be performed as shown in FIG. 13.

Specifically, when the worker has changed the target and the mode, the third specification unit 17 reads out the worker information and the position from the second data table 85 created through the worker specifying process and the position specifying process (step ST111 and step ST112 in FIG. 13). Next, similarly to embodiment 2 above, a list of targets is displayed. The worker selects one target from the list, whereby the target is specified (step ST117 in FIG. 13).

Next, similarly to embodiment 2 above, in accordance with the specified target, the third specification unit 17 narrows the corresponding mode on the basis of the second data table 85, and creates the third data table 95. Next, the fourth specification unit 18 displays a list of modes. The worker selects one mode from the list, whereby the mode is specified (step ST114 in FIG. 13).

Next, similarly to the afore-described cases, with respect to the specified mode, and the worker, the position and the target that have been specified in advance and read out, the recording unit 13 specifies the activity time obtained from the timer 10 (step ST115 in FIG. 13). Then, these are saved as the activity data in the storage (step ST116 in FIG. 13).

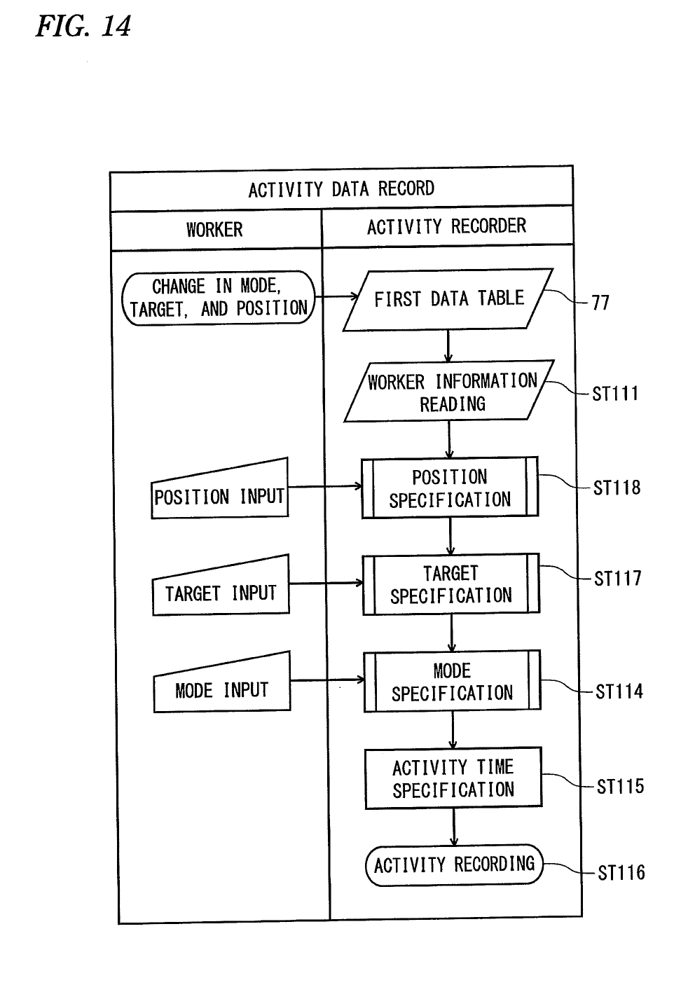

As another example, in a case where the worker is unchanged, and the position, the target, and the mode are changed, a process similar to that in embodiment 3 above can be performed as shown in FIG. 14.

Specifically, when the worker has changed the position, the target, and the mode, the second specification unit 16 reads out the worker information from the first data table 77 created through the worker specifying process (step ST111 in FIG. 14). Next, similarly to embodiment2 above, a list of positions is displayed. The position selects one target from the list, whereby the position is specified (step ST118 in FIG. 14).

Next, similarly to embodiment 2 above, in accordance with the specified position, the second specification unit 16 narrows the corresponding mode on the basis of the first data table 77, and creates the second data table 85.

Next, similarly to embodiment 2 above, the third specification unit 17 displays a list of targets on the basis of the second data table 85. The worker selects one target from the list, whereby the target is specified (step ST117 in FIG. 14).

Next, similarly to embodiment 2 above, in accordance with the specified target, the third specification unit 17 narrows the corresponding mode on the basis of the second data table 85, and creates the third data table 95. Next, the fourth specification unit 18 displays a list of modes. The worker selects one mode from the list, whereby the mode is specified (step ST114 in FIG. 14).

Next, similarly to the afore-described cases, with respect to the specified mode, and the worker, the position, and the target that have been specified in advance and read out, the recording unit 13 specifies the activity time obtained from the timer 10 (step ST115 in FIG. 14). Then, these are saved as the activity data in the storage (step ST116 in FIG. 14).

According to embodiment 3 configured as above, it is needless to say that similar effects to those in the embodiments above are exhibited. In addition, the relationship DB having been narrowed once can be used again. Thus, the activity data can be recorded accurately and in a short process.

### Embodiment 4

The relationship DB 19 (see FIG. 6) in embodiment 2 above has a problem in that the entirety of one DB needs to be modified when an element in a column is changed. In addition, it is necessary to register all information in one table, which causes a problem of a great burden in constructing the DB. Therefore, in the present embodiment, some internal variables are prepared to divide the table, thereby facilitating management and construction thereof.

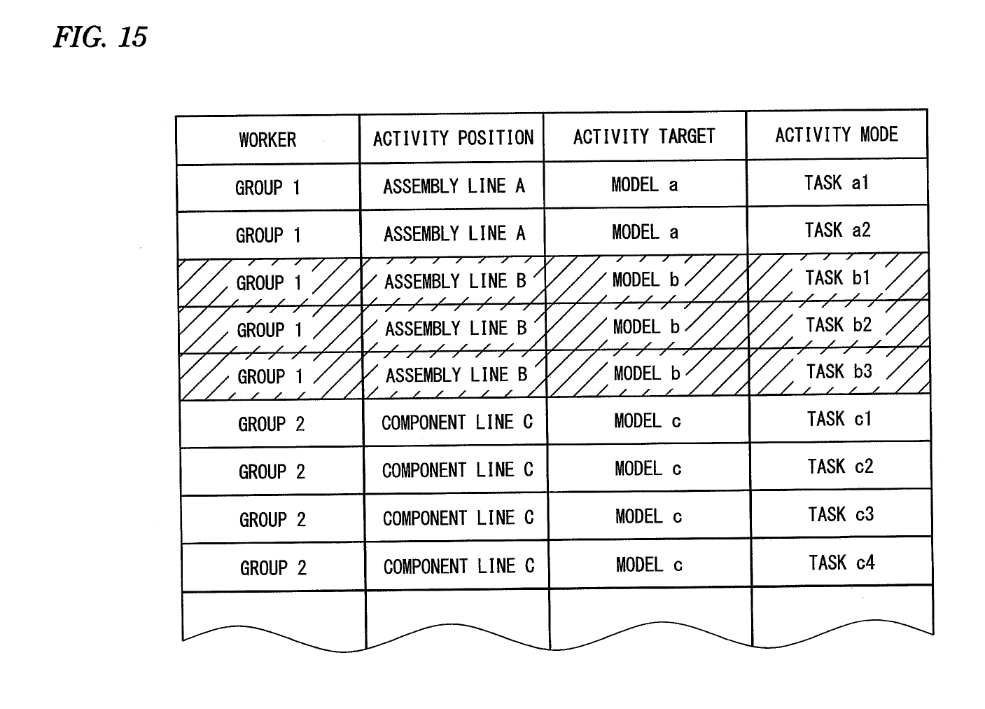

FIG. 15 is the relationship DB 19 of the present embodiment. The column “worker” indicates “group”, which is different from “worker ID” in FIG. 6. The column “position” indicates “assembly line” or “component line”, which is different from “facility” in FIG. 6. The column “target” indicates “model”, which is the same as that in FIG. 6. The column “mode” indicates “task”, which is the same as that in FIG. 6.

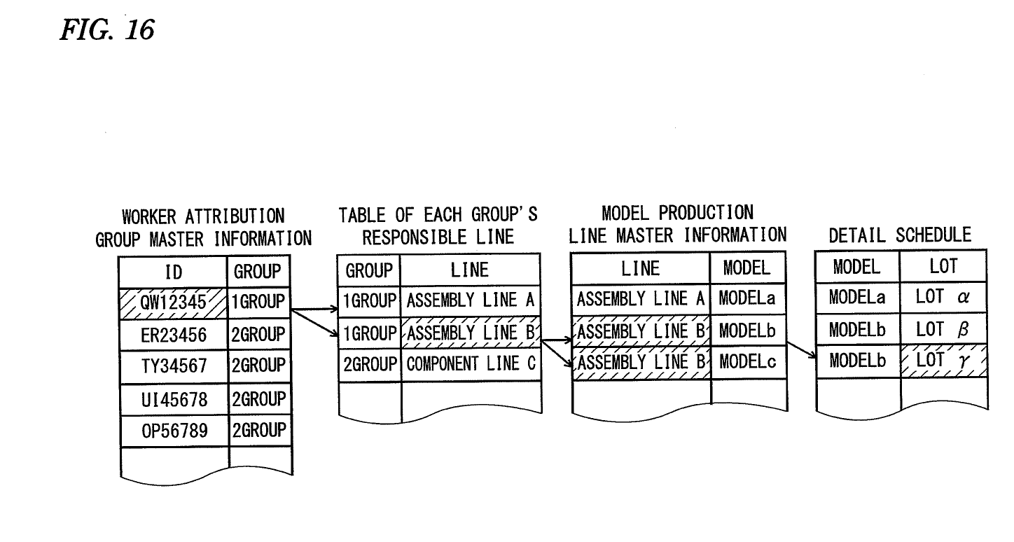

FIG. 16 shows a procedure of activity data recording that uses this relationship DB 19.

First, generally, at a production site, workers are managed not individually, but in terms of each organization unit, such as a group, that the workers belong to. Thus, in the relationship DB 19, “group” is used as the item that corresponds to the worker, and an internal table of worker attribution group master information that defines which group each worker ID belongs to is provided. Through this table, when the worker selects his/her ID, the corresponding group can be registered as the worker. This table can be created from a personnel management system or the like existing in the plant.

In addition, a table of each group's responsible line which indicates correspondence between group and line is provided as an internal table. This is a list of positions where group members of each group could engage in activities, and can easily be created from a production management system or the like existing in the plant.

When the worker selects QW12345 which is his/her worker ID from the worker ID list displayed on the display 8 and inputs QW12345, the fact that the worker belongs to group 1 is determined on the basis of the internal table. The lines corresponding to group 1 are narrowed to line A and line B on the basis of the internal table, and are highlighted in the position list on the display 8 of the activity recorder. An internal variable is used as the key for the narrowing on the internal table, and in this case, the internal variable is “group”.

In addition, model production line master information which indicates correspondence between line and model is provided as an internal table. This is a list of models that could be produced in each line. This table can also be created from a production management system or the like existing in the plant.

When the worker selects line B from the list of lines displayed on the screen of the display 8, the corresponding models are narrowed to model b and model c on the basis of the internal table, and are displayed on the display 8. In this case, “line” functions as the internal variable.

In addition, an internal table which indicates correspondence between model and lot is provided. This is a table that indicates correspondence, on a drawing, between model and each lot actually produced in a line every day, and can be created from a detail schedule or the like of the plant, for example.

At the time point when an assembly line has been specified by the worker, a list of lots that could be produced is displayed on the display 8 of the activity recorder, using the model produced on the line as the internal variable.

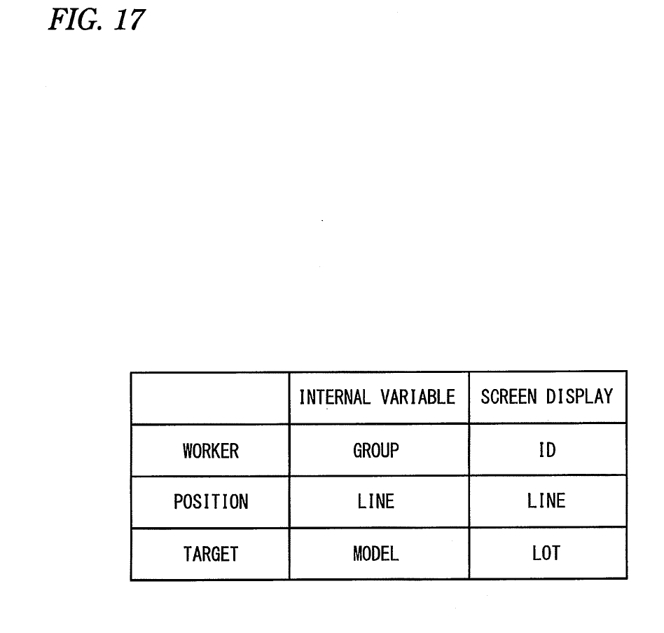

As described above, since the DB is provided with the internal variables and the internal tables, a DB that can be more easily managed can be constructed. FIG. 17 shows correspondence between internal variable and screen display. With respect to the worker, the worker ID is displayed on the screen. However, inside the DB, assembly lines associated with the worker specified by the ID are narrowed by using the group as a key. The narrowed assembly lines are displayed on the screen. When an assembly line is specified from the displayed assembly lines, lots related to the specified assembly line are narrowed in the inside of the DB, by using the model as a key. The narrowed lots are displayed on the screen.

Thus, there are cases where elements actually displayed on the screen to the worker and the reference columns of elements that are used as keys for the DB are different from each other. This is because internal variables that are easy to be managed in the DB are used as variables for the DB, and variable that are easy to be selected and understood by the worker are selected as variables to be displayed on the screen.

According to embodiment 4 configured as above, it is needless to say that similar effects to those in the embodiments above are exhibited. In addition, by using the relationship DB and previously specifying the worker, the position, and the target, possible modes can be narrowed. In addition, a mode that is most frequently selected among the elements of the activity data can be efficiently selected.

### Embodiment 5

With respect to an activity recorder of embodiment 5 of the present invention, completion of a task and suspension of a task are described. Completion of a task and suspension of a task are each set as one of modes.

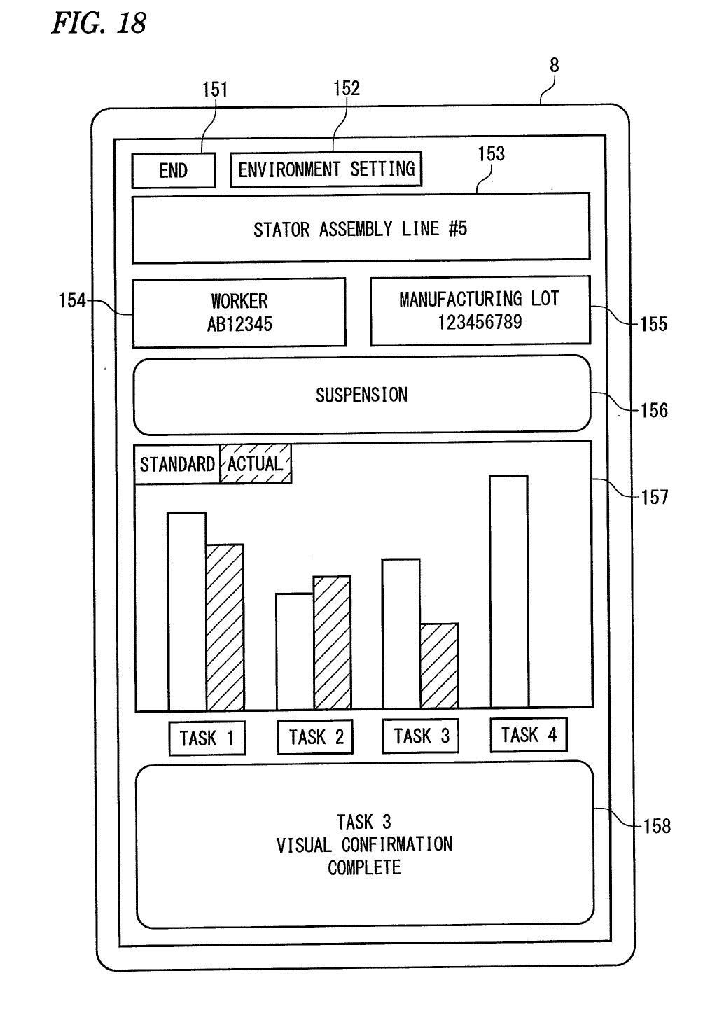

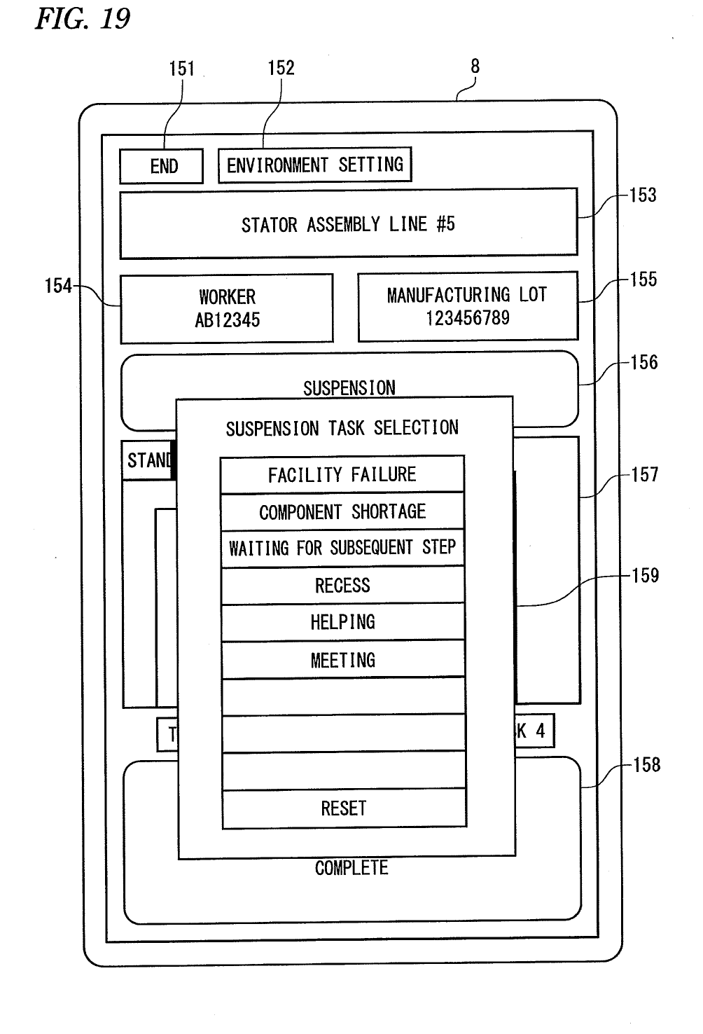

FIG. 18 and FIG. 19 each show a display example of the display 8 of the activity recorder 11. With reference to FIG. 18, an execution screen for software which records the activity data is displayed on the display 8. In an uppermost part of the screen, an end button 151 for the software and an environment setting button 152 for operation of the software are displayed.

A position display part 153 corresponds to position information in the activity data. In the present embodiment, a case is shown in which a selection is made from a list of positions at which a worker can engage in activities. A worker display part 154 corresponds to the worker in the activity data. A target display part 155 corresponds to the target in the activity data. For a worker who works at a position specified in advance, the target means “which manufacturing lot is to be produced”.

Therefore, manufacturing lots which are targets and which can be worked at the manufacturing line which is the position are obtained in advance, and are stored in the storage in the activity recorder 11. Then, selection is allowed to be made from the list of these targets. This target list corresponds to the position-target spreadsheet in embodiment 1.

A suspension button 156 is a button that is pressed when recording of the activity data is to be suspended. When the suspension button 156 is pressed, a plurality of suspension task options are popped up 159 as in FIG. 19. The plurality of suspension tasks represents a list of suspension tasks stored in the storage in advance. The suspension task list is a list that has, as elements, only non-steady tasks among modes in the embodiments described above.

When any one of suspension tasks is selected, the fourth specification unit 18 specifies the selected suspension task as the mode of the activity data. Further, the recording unit 13 records, as the activity data, the worker, the position, and the target that have been specified, with the selected suspension task set as the mode, and with a specified time added as the activity time so as to be associated with the worker, the position, the target, and the mode. Then, when one corresponding suspension task is selected from the suspension task list, the screen returns to the screen shown in FIG. 18. Thus, the time point at which the suspension button 156 is pressed first is the time point at which suspension of the suspension task starts, and the time point at which selection is made on the suspension task list is the time point at which the suspension of the suspension task ends. However, this is merely one example, and another selection method may be employed.

A task completion button 158 is pressed by the worker every time a steady task among the modes changes, i.e., every time the task is completed.

On the task completion button 158, task contents that the worker should perform and cautions at that time point can be displayed by utilizing characteristics of the touch panel.

When the task completion button 158 is pressed, the recording unit 13 records, as the activity data, the worker, the position, the target, and the mode that have been specified, with the time at which the task was completed added as the activity time so as to be associated with the worker, the position, the target, and the mode. Further, on the basis of the time at which the task was completed and the time at which the task was firstly specified, i.e., the start time of the task, an actual task time period is calculated. Then, the actual task time period and a standard task time period set in advance are displayed in contrast with each other, in a graph display part 157 of the display 8.

The graph display part 157 is displayed in the form of a graph which represents information indicating work efficiency of the worker, with the actual task time period shown in comparison with a standard task time period set in advance for each task. In FIG. 18, a bar graph is displayed in which, for each of task 1, task 2, task 3, and task 4 which are modes of steady tasks among the modes, a standard task time period that is standard for performing the task is compared with the actual task time period that was actually taken. Thus, useful information based on the activity data can be presented to the worker.

In the present embodiment, the worker mainly presses the task completion button 158. Thus, in order not to impair the workability of the worker, the task completion button 158 is large-sized and is arranged at the lowermost part that is less likely to cause erroneous pressing of the button. In addition, the graph display part 157 is arranged immediately above the task completion button 158. Since the worker can confirm the task time period by shifting the direction of eyes when pressing the task completion button 158, the graph display part 157 can be used as a pacemaker.

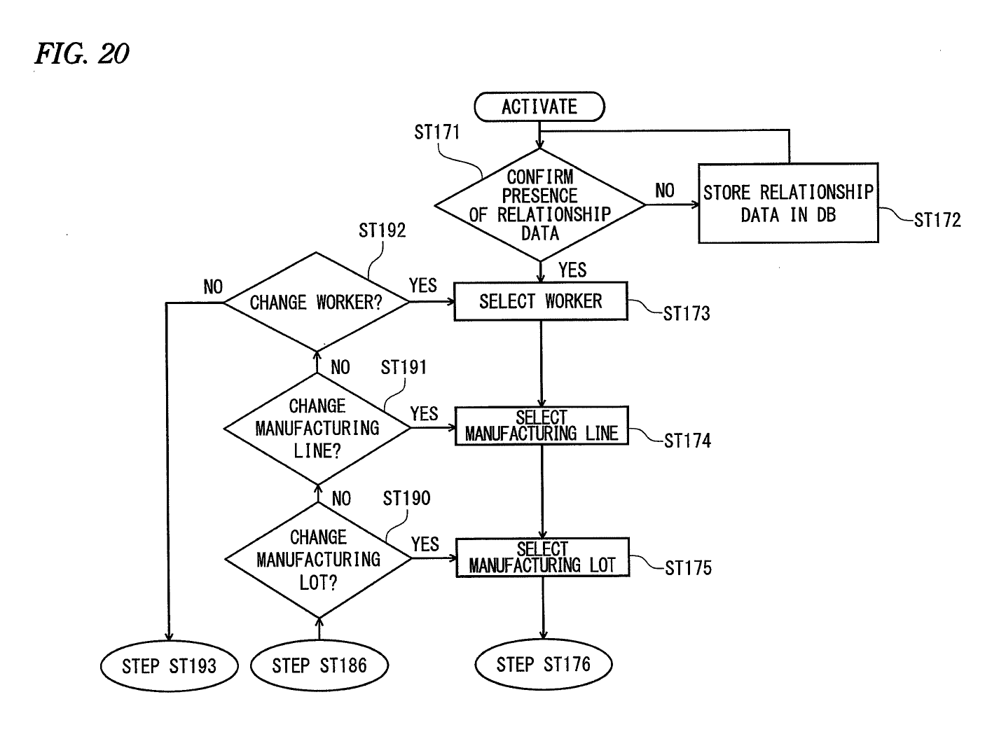

FIG. 20 to FIG. 22 each show a processing flow chart for the activity recorder shown in FIG. 18 according to the present embodiment. In the present embodiment, the worker is assumed to engage in a mass production process in which cycle operation is performed in a determined line that the worker is in charge of. In this case, the position is described as the manufacturing line that the worker engages in. The target is described as the manufacturing lot. The mode is the minimum unit that has been set, among tasks performed in one cycle that are performed on each individual workpiece in the manufacturing lot. Therefore, the mode is specified in advance as task 1, task 2, task 3, and task 4, and description is given, using task 1 through task 4, or using, as the mode, a suspension task that occurs when the cycle operation is suspended.

First, when the worker has activated the activity recorder 11, an application as the activity recording program which records the activity data (hereinafter, referred to as “application”) is executed. The application confirms whether or not relationship data of the relationship DB 19 is present, first (step ST171 in FIG. 20). When the relationship data of the relationship DB 19 is not present (NO), relationship data is obtained from outside and stored in the relationship DB 19 in the storage of the activity recorder 11 (step ST172 in FIG. 20). When the data of the relationship DB 19 is present (YES), the application loads the content of the relationship DB 19.

Next, before starting a production activity, the worker selects items of worker, position, and target in the activity data.

First, the worker is selected (step ST173 in FIG. 20). In accordance with the selected worker, the activity recorder 11 creates a list of manufacturing lines that the worker can engage in, and presents the list to the worker through the screen of the display 8.

Next, the worker selects a manufacturing line that the worker engages in, from the displayed list of manufacturing lines (step ST174 in FIG. 20). In accordance with the selected manufacturing line, the activity recorder 11 creates a list of manufacturing lots that are produced in the manufacturing line, and presents the list to the worker through the screen of the display 8.

Next, the worker selects a manufacturing lot of which production is started in the manufacturing line, from the displayed target list (step ST175 in FIG. 20). In accordance with the selected target, the activity recorder 11 creates a list of tasks that are to be performed on a workpiece (hereinafter, simply referred to as “task”) and suspension tasks and saves the list in an internal memory.

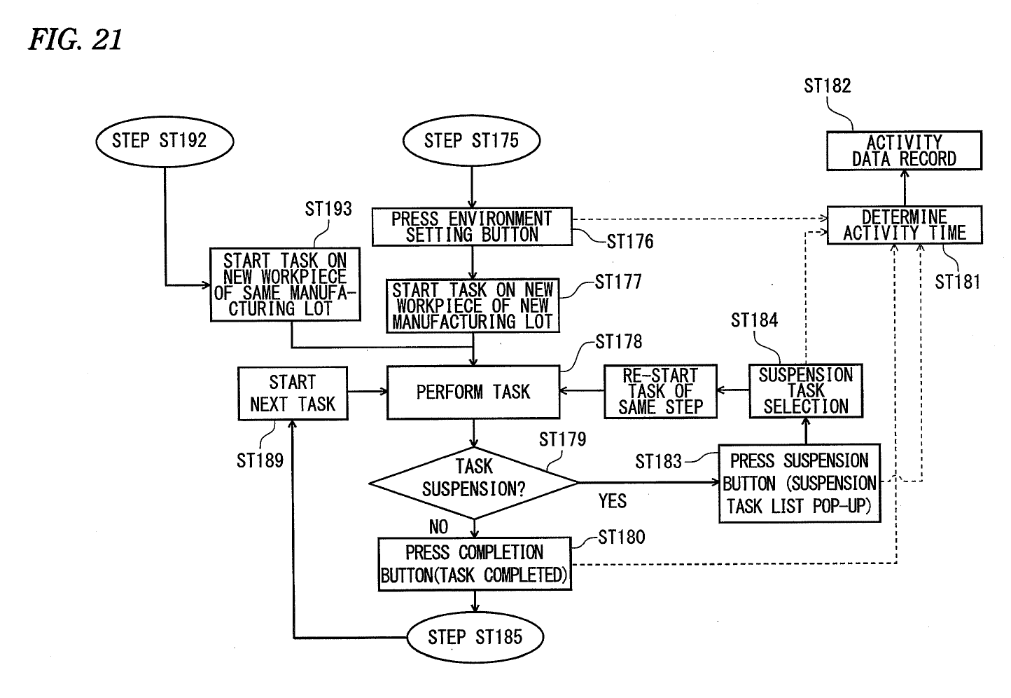

Then, the preparation before production start is ended, and the environment setting button is pressed (step ST176 in FIG. 21). Then, the task for the switched new manufacturing lot is started (step ST177 in FIG. 21). Next, the task is performed (step ST178 in FIG. 21). Next, whether or not to suspend the task is determined (step ST179 in FIG. 21).

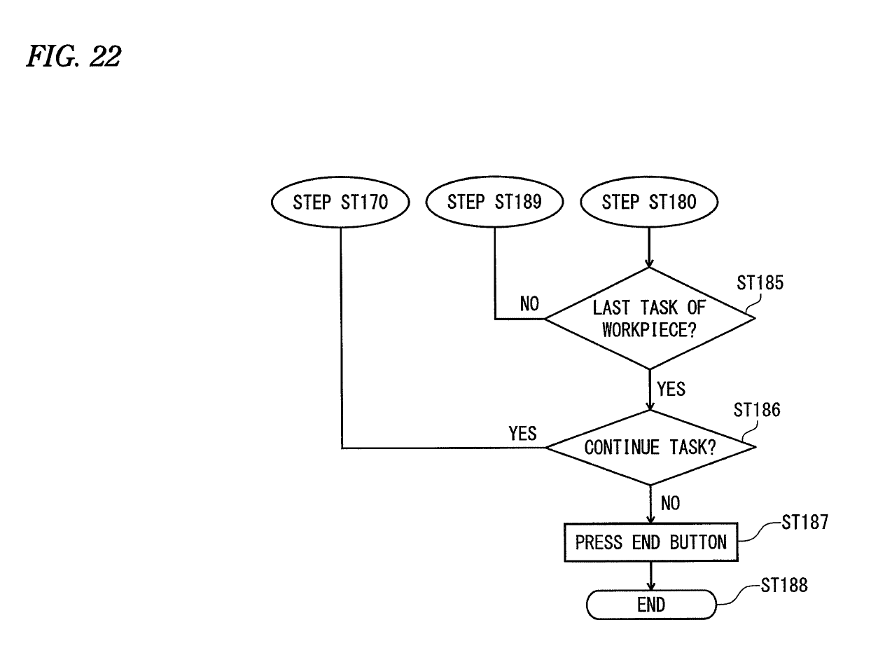

Usually, the task is not suspended and thus, the result of the determination is (NO) which means that the task is not suspended. Then, when the task as the mode is completed, the completion button is pressed (step ST180 in FIG. 21). Every time the completion button is pressed, the activity time is determined (step ST181 in FIG. 21). Then, the activity time is saved as the activity data into the storage of the activity recorder 11 (step ST182 in FIG. 21). Further, whether or not the task is the last task for the manufacturing lot is determined (step ST185 in FIG. 22).

In the present embodiment, the sequence of tasks as the mode is determined in advance as task 1 −> task 2 −> task 3 −> task 4. Thus, the time at which the task completion button is pressed serves as the start time for the next task. When the result of the determination is YES, the next task is started (step ST189 in FIG. 21). Then, the same process as described above is repeated. In this case, there is no need to press the button of selecting the next task for the mode.

In a case where the task is to be suspended in the middle of the task, the suspension button 156 is pressed and the result of the determination in step ST179 for determining where whether or not to suspend the task becomes YES. Next, the suspension task list is popped up (step ST183 in FIG. 21).

This time point is determined as the activity time at which the task suspension is started (step ST181 in FIG. 21). Then, at this time point, the activity data indicating the task suspension is recorded (step ST182 in FIG. 21).

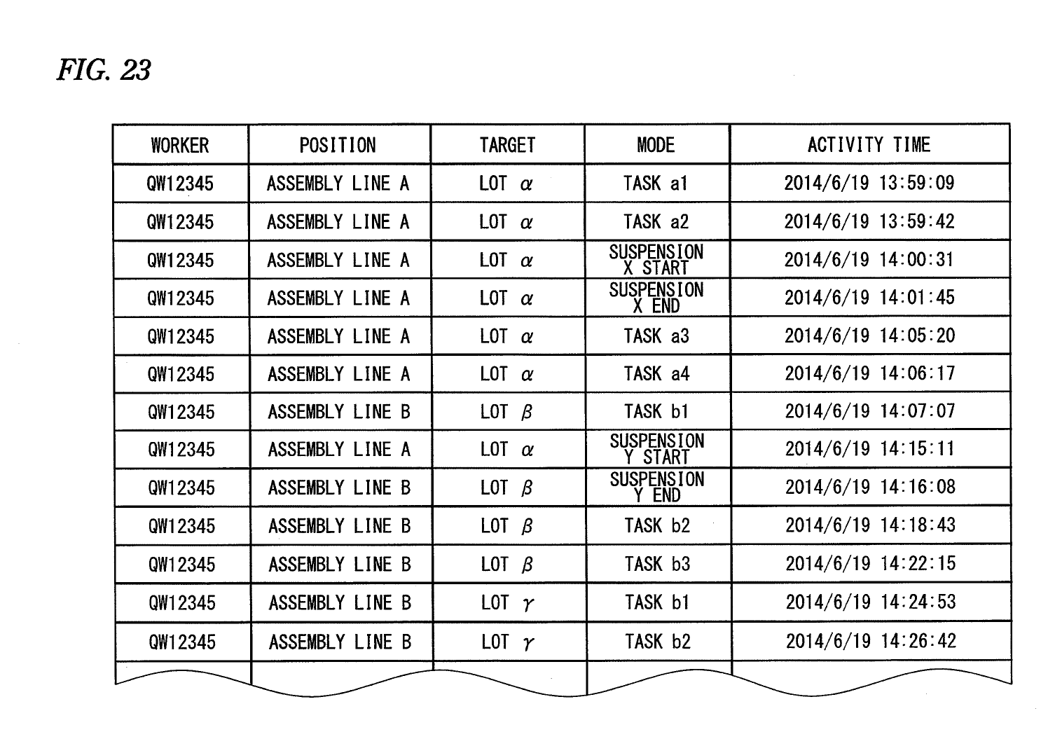

Next, the worker performs the suspension task, and at the end of the suspension task, selects the suspension task from the suspension task list (step ST184 in FIG. 21). Then, with the suspension task set as the mode, the activity time at which the suspension task ended is determined (step ST181 in FIG. 21). Then, the activity data indicating the end of the suspension task is recorded in the storage of the activity recorder (step ST182 in FIG. 21). At this time, the mode corresponding to the start time of the suspension task is also determined, and the mode is also recorded. Specifically, the activity data associated with the suspension task as shown in FIG. 23 is recorded.

When one cycle, i.e., task 1 through task 4, has ended, the result of the determination in step ST185 for determining whether or not the task is the last task becomes YES, and the worker selects whether or not to continue the task further (step ST186 in FIG. 21).

When the worker does not continue the task, the worker presses the end button to end the production activity (step ST187 in FIG. 21), and stops the activity recorder (step ST188 in FIG. 21).

When the worker continues the task, the presence/absence of change in the target, the position, and the worker is determined in this order (step ST190 to step ST192 in FIG. 21). When there is a change, a selection is made from a corresponding list, and the same process as described above is newly performed, to determine each element. When no change is made, a task is newly started from task 1 onto a new workpiece of the same lot (step ST193 in FIG. 21).

Through the above flow, each element of the activity data can be recorded at each change point of the mode.

According to embodiment 5 configured as above, it is needless to say that similar effects to those in the embodiments above are exhibited. In addition, while each task is being performed in each cycle, the actual task time period in past activity data in the cycle is displayed in the form of a bar graph together with the standard time period. Accordingly, by the worker comparing his/her own task with the standard in real time, the worker's learning toward the standard level can be promoted.

In the present embodiment, when the worker performs task change point inputting, the direction of eyes of the worker is directed to the display. Thus, it is possible to reliably cause the worker to confirm task instructions and task time period data which are necessary in obtaining task skills and which are displayed on the screen of the display.

In addition, since the suspension task can be specified as the mode and added to the activity data, precise activity data can be recorded.

### Embodiment 6

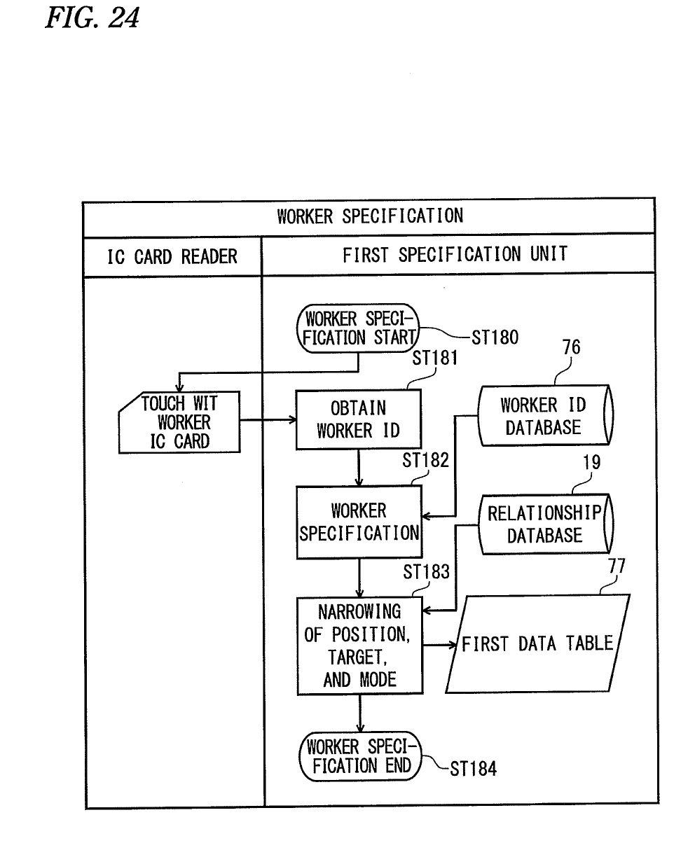

FIG. 24 shows a processing flow used when an IC card reader is used as the input unit for the first specification unit 15 in an activity recorder of embodiment 6 of the present invention.

The worker specifying process is started (step ST180 in FIG. 24). The worker touches the IC card reader with the IC card that the worker owns. Then, the IC card reader reads ID information in the card and the first specification unit 15 obtains a worker ID (step ST181 in FIG. 24). The first specification unit 15 searches the worker ID DB 76 for the worker ID, to specify the worker (step ST182 in FIG. 24).

Then, similarly to the embodiments above, in accordance with the specified worker, the first specification unit 15 narrows the corresponding position, target, and mode on the basis of the relationship DB 19 to extract relationship data, and creates the first data table 77 (step ST183 in FIG. 24). After the above process, the worker specifying process ends (step ST184 in FIG. 24).

According to embodiment 6 configured as above, it is needless to say that similar effects to those in the embodiments above are exhibited. In addition, worker input that does not require display of a worker list can be realized.

### Embodiment 7

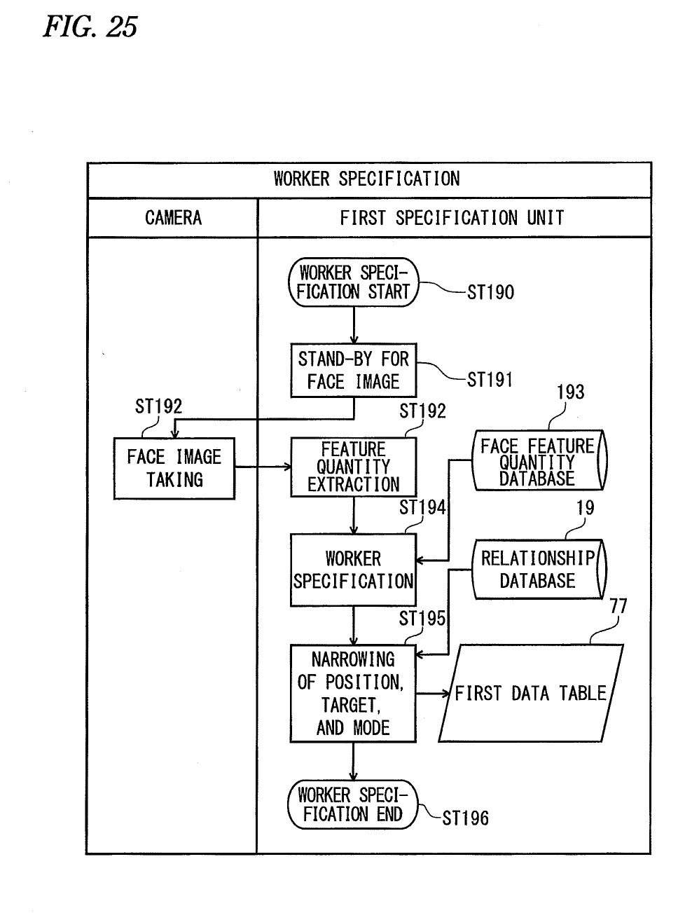

FIG. 25 shows a processing flow used when a face recognition camera is used as the input unit for the first specification unit 15 in an activity recorder of embodiment 7 of the present invention.

The worker specifying process is started (step ST190 in FIG. 25). The first specification unit 15 causes a face recognition camera to stand by for taking an image of the face of the worker (step ST191 in FIG. 25). In this state, the face recognition camera takes an image of the face of the worker. The first specification unit 15 extracts a feature quantity from the taken face image (step ST192 in FIG. 25). Next, the first specification unit 15 checks the feature quantity against a face feature quantity DB 193 created for each worker in advance, and specifies the worker (step ST194 in FIG. 25).

Then, similarly to the embodiments above, in accordance with the specified worker, the first specification unit 15 narrows the corresponding position, target, and mode on the basis of the relationship DB 19 to extract relationship data, and creates the first data table 77 (step ST195 in FIG. 25). After the above process, the worker specifying process ends (step ST196 in FIG. 25).

According to embodiment 7 configured as above, it is needless to say that similar effects to those in the embodiments above are exhibited. In addition, the worker can be specified without depending on another physical device such as an IC card.

### Embodiment 8

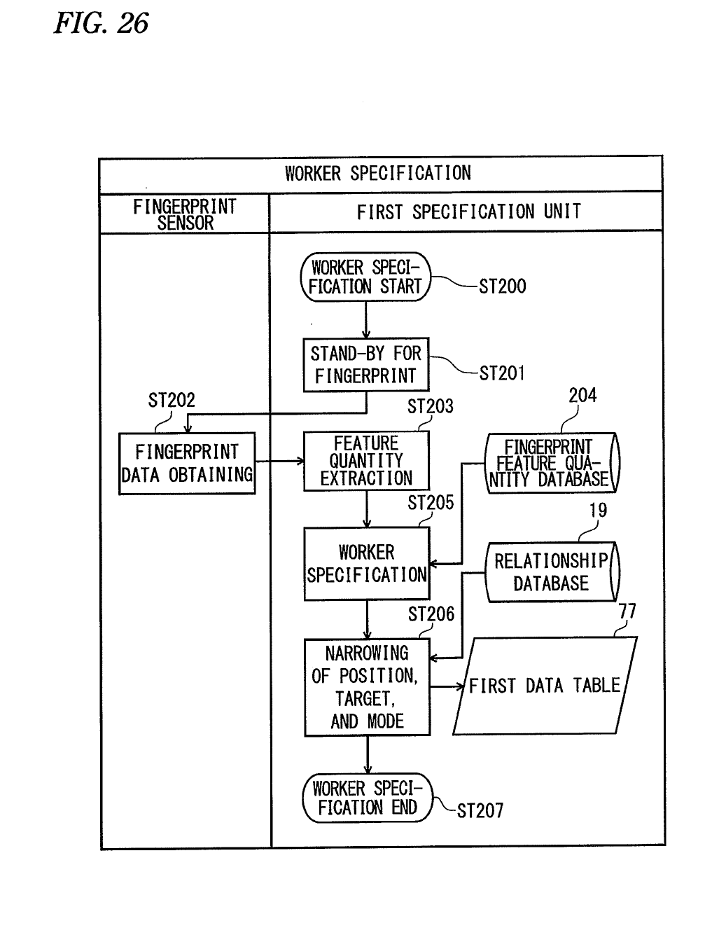

FIG. 26 shows a processing flow used when a fingerprint sensor is used as the input unit for the first specification unit 15 in an activity recorder of embodiment 8 of the present invention.

The worker specifying process is started (step ST200 in FIG. 26). The first specification unit 15 causes a fingerprint sensor to stand by for obtaining a fingerprint of the worker (step ST201 in FIG. 26).

In this state, the worker touches the fingerprint sensor with a finger, and the fingerprint sensor obtains fingerprint data (step ST202 in FIG. 26). Next, the first specification unit 15 extracts a feature quantity from the data obtained by the fingerprint sensor (step ST203 in FIG. 26). Next, the first specification unit 15 checks the feature quantity against a fingerprint feature quantity DB 204 created from a fingerprint of each worker in advance, and specifies the worker (step ST205 in FIG. 26).

Then, similarly to the embodiments above, in accordance with the specified worker, the first specification unit 15 narrows the corresponding position, target, and mode on the basis of the relationship DB 19 to extract relationship data, and creates the first data table 77 (step ST206 in FIG. 26). After the above process, the worker specifying process ends (step ST207 in FIG. 26).

According to embodiment 8 configured as above, it is needless to say that similar effects to those in the embodiments above are exhibited. In addition, the worker can be specified without depending on another physical device such as an IC card.

### Embodiment 9

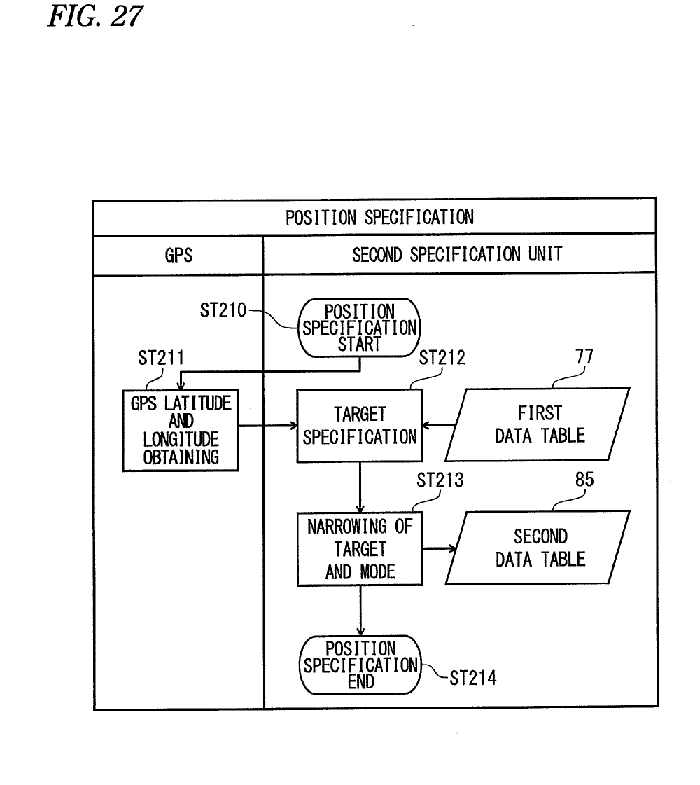

FIG. 27 shows a processing flow used when a GPS device (Global Positioning System) is used as the input unit for the second specification unit 16 in an activity recorder of embodiment 9 of the present invention.

The position specifying process is started (step ST210 in FIG. 27). The GPS device obtains latitude-longitude information (step ST211 in FIG. 27).

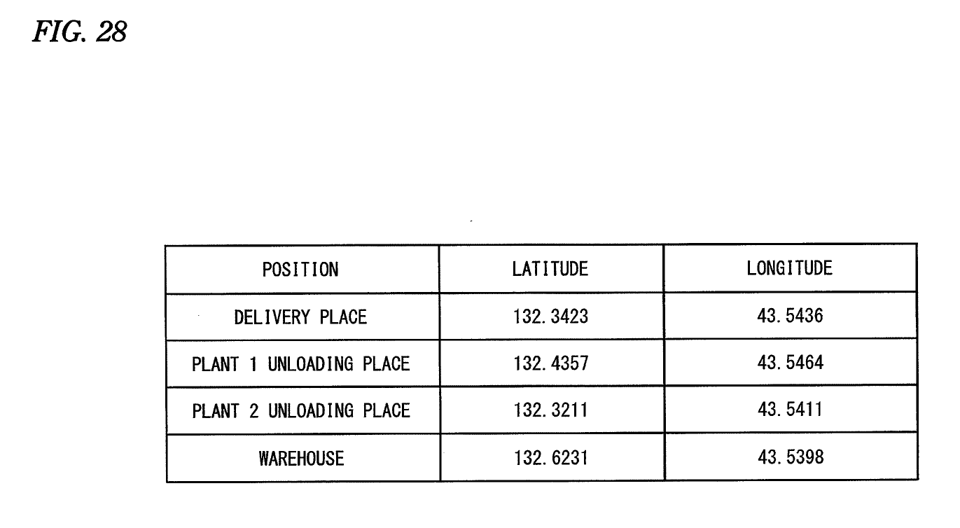

In addition, the second specification unit 16 obtains a position from the first data table 77 created in the worker specifying process. As shown in FIG. 28, the table has data consisting of combinations of: a position at which the worker can perform an activity; and the latitude and the longitude at that position.

Next, similarly to the embodiments above, the second specification unit 16 checks calculated latitude-longitude information from the GPS device against the first data table 77, and specifies a most appropriate position in the manufacture site (step ST212 in FIG. 27). In accordance with the specified position, the second specification unit 16 narrows the corresponding target and mode on the basis of the first data table 77, and creates the second data table 85 (step ST213 in FIG. 27). After the above process, the position specifying process ends (step ST214 in FIG. 27).

According to embodiment 9 configured as above, it is needless to say that similar effects to those in the embodiments above are exhibited. In addition, position specification that does not require input by the worker can be realized.

### Embodiment 10

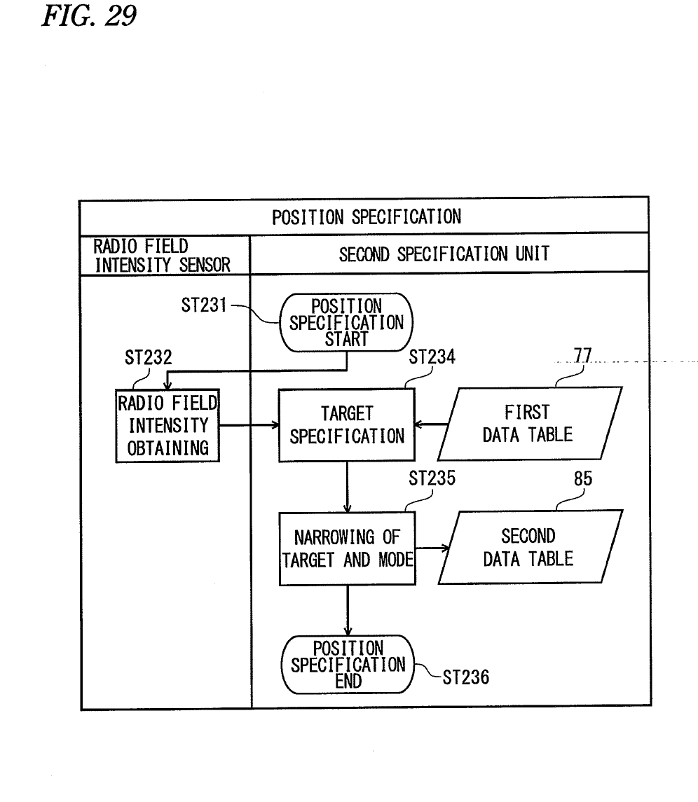

FIG. 29 shows a processing flow used when a sensor (for example, a case of a radio field intensity sensor is described) is used that measures the radio field intensity of a radio wave transmitter (for example, a case of a beacon is described) installed in the plant in advance, the sensor being used as the input unit for the second specification unit in an activity recorder of embodiment 10 of the present invention.

First, beacons are installed at places that can serve as positions in the plant. Individual beacons are respectively assigned with different IDs, and each beacon repeatedly transmits a radio wave having an equal intensity.

The position specifying process is started (step ST231 in FIG. 29). Next, by use of a radio field intensity sensor, a set of an ID and a radio field intensity value received from each beacon is obtained (step ST232 in FIG. 29).

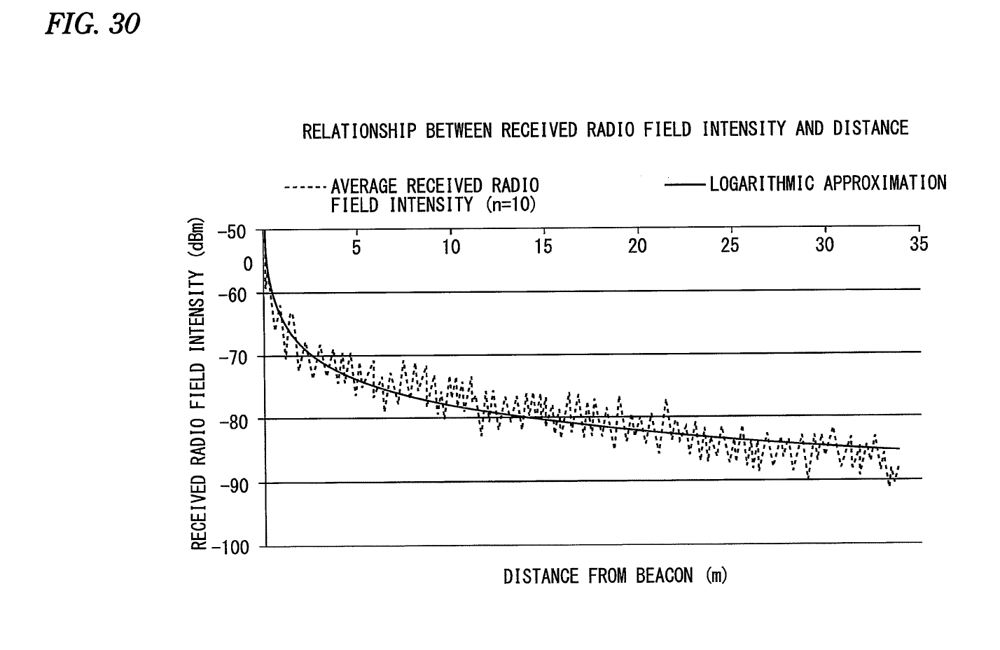

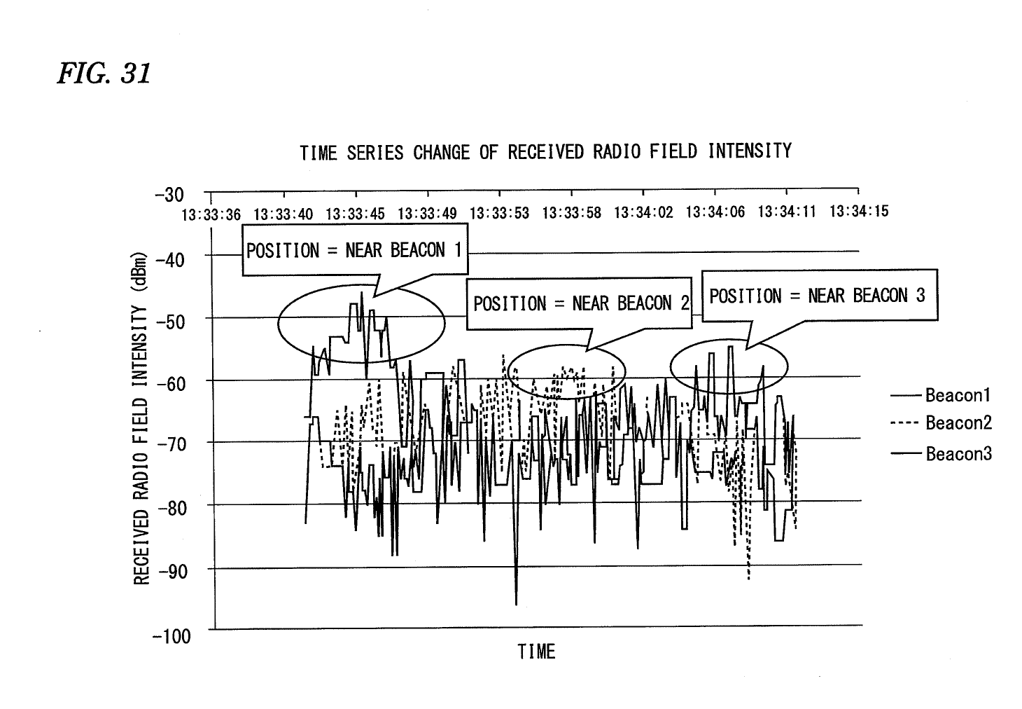

The value of radio field intensity measured by the radio field intensity sensor decreases in accordance with increase in the distance from the beacon (see FIG. 30). Therefore, when the radio field intensity values received from the respective beacons are compared with one another, and if only one beacon shows radio field intensity values that are higher than or equal to a certain level, the position can be specified as being close to this beacon (see FIG. 31).

In addition, the second specification unit 16 obtains a position from the first data table 77 created in the worker specifying process.

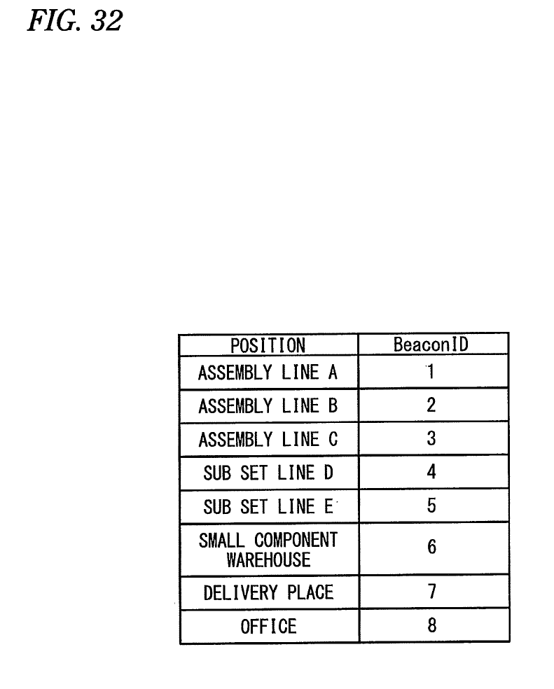

As shown in FIG. 32, the data table has data consisting of combinations of: a position at which the worker can perform an activity; and a beacon ID installed therein.

Next, similarly to the embodiments above, the second specification unit 16 checks the beacon ID obtained by the radio field intensity sensor against the first data table 77, and specifies a most appropriate position in the manufacture site (step ST234 in FIG. 29). In accordance with the specified position, the second specification unit 16 narrows the corresponding target and mode on the basis of the first data table 77, and creates the second data table 85 (step ST235 in FIG. 29). After the above process, the position specifying process ends (step ST236 in FIG. 29).

According to embodiment 10 configured as above, it is needless to say that similar effects to those in the embodiments above are exhibited. In addition, even in such a place inside a building where the GPS device cannot be used, position specification that does not require input by the worker can be realized.

### Embodiment 11

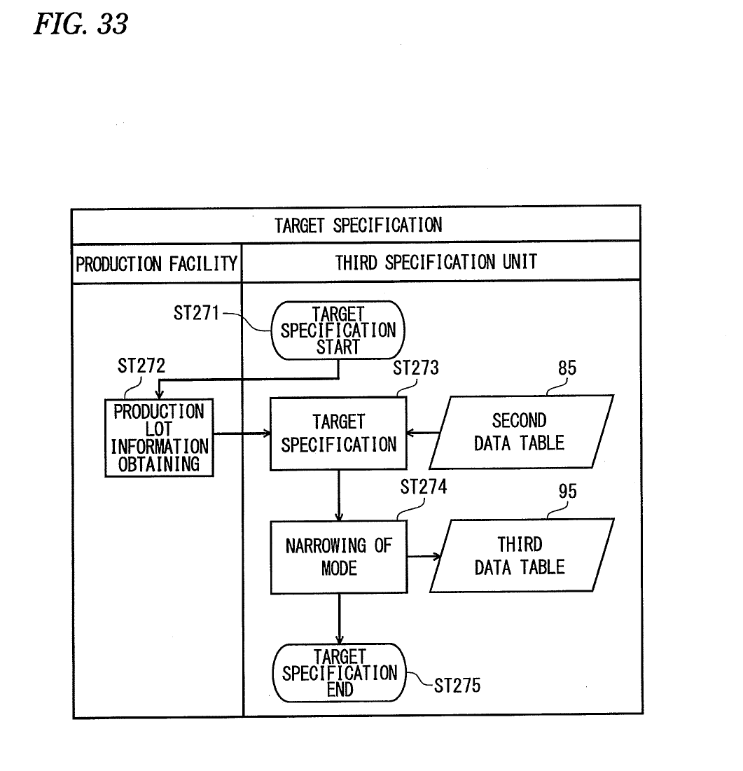

FIG. 33 shows a processing flow used when a sensor is used that is connected to a production facility and that obtains information of a target obtained from the production facility, the sensor being used as the input unit for the third specification unit 17 in an activity recorder of embodiment 11 of the present invention.

The target specifying process is started (step ST271 in FIG. 33). From the production facility to which the sensor is connected, the sensor obtains, as the target, information of a product lot being produced at the facility (step ST272 in FIG. 33).

Next, similarly to the embodiments above, the third specification unit 17 checks the information of the target obtained from the sensor against the second data table 85, searches for the same target as the target obtained from the production facility, and specifies the target (step ST273 in FIG. 33).

In accordance with the specified target, the third specification unit 17 narrows the corresponding mode on the basis of the second data table 85, and creates the third data table 95 (step ST274 in FIG. 33). After the above process, the target specifying process ends (step ST275 in FIG. 33).

According to embodiment 11 configured as above, it is needless to say that similar effects to those in the embodiments above are exhibited. In addition, target specification that does not require input by the worker can be realized.

### Embodiment 12

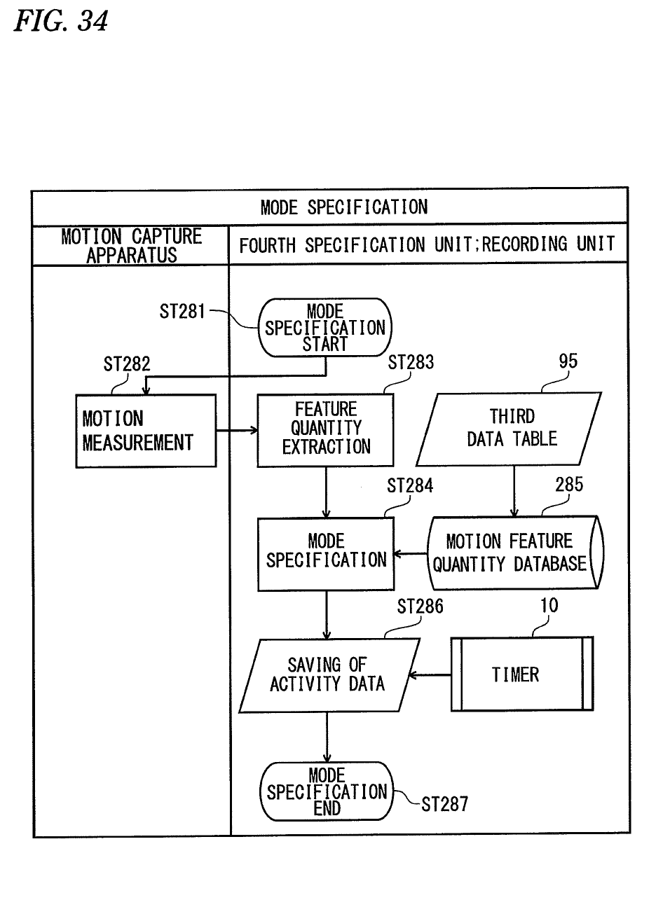

FIG. 34 shows a processing flow used when a motion capture apparatus is used as the input unit for the fourth specification unit 18 in an activity recorder of embodiment 12 of the present invention. The motion capture apparatus is an apparatus that expresses, in terms of numerical values, the positions and angles of major joints (shoulder, elbow, finger, hip, knee, etc.) in motions of a person on the basis of a video or the like taken by a video camera or the like, and that records the numerical values. For example, the motion capture apparatus is an acceleration sensor, a gyro sensor, a camera, or the like built in a tablet terminal carried by the worker.

The mode specifying process is started (step ST281 in FIG. 34). The motion capture apparatus measures a motion of the worker (step ST282 in FIG. 34). The fourth specification unit 18 extracts a feature quantity from the measured motion (step ST283 in FIG. 34).

With respect to each mode that is included in the third data table 95 and that the worker can take, a motion feature quantity DB 285 formed by extracting features of motion that allow the mode to be distinguished from other modes has been created in advance.

Next, similarly to the embodiments above, from the motion feature quantity DB 285, the fourth specification unit 18 finds a motion having a feature quantity that is closest to the measured motion feature quantity, checks the found motion against the third data table 95, and specifies the motion as the mode (step ST284 in FIG. 34).

The recording unit 13 saves, into the storage, the activity data composed of: the specified mode and the worker, position, and target that have been specified; and the activity time obtained from the timer 10 added thereto (step ST286 in FIG. 34). After the above process, the mode specifying process ends (step ST287 in FIG. 34).

According to embodiment 12 configured as above, it is needless to say that similar effects to those in the embodiments above can be exhibited. In addition, mode specification that does not require input by the worker can be realized.

### Embodiment 13

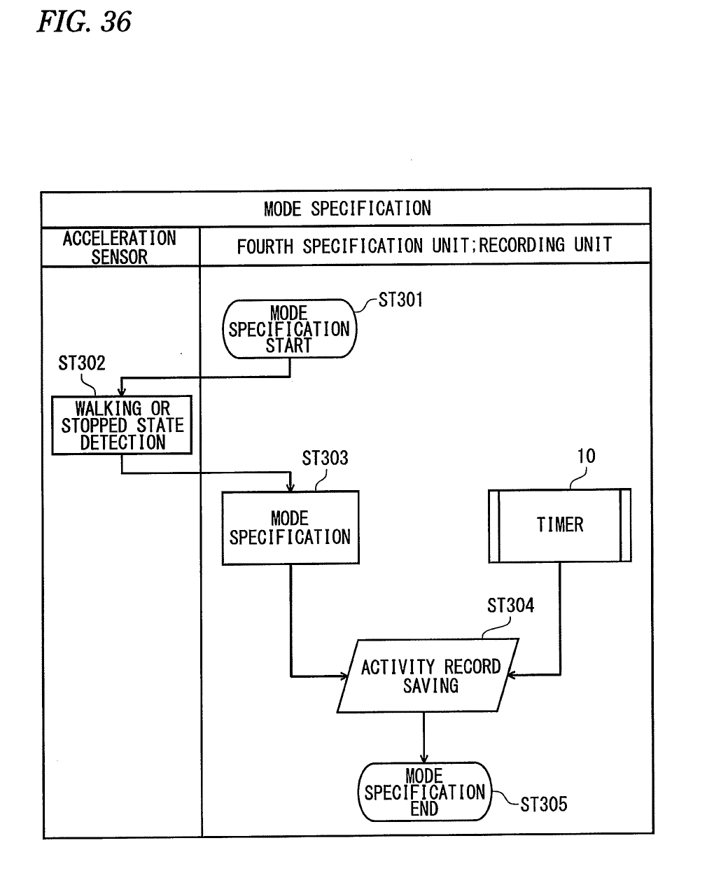

FIG. 36 shows a processing flow used when a number-of-steps measuring apparatus that uses an acceleration sensor (so-called pedometer (registered trademark)) is used as the input unit for the fourth specification unit 18 in an activity recorder of embodiment 13 of the present invention.

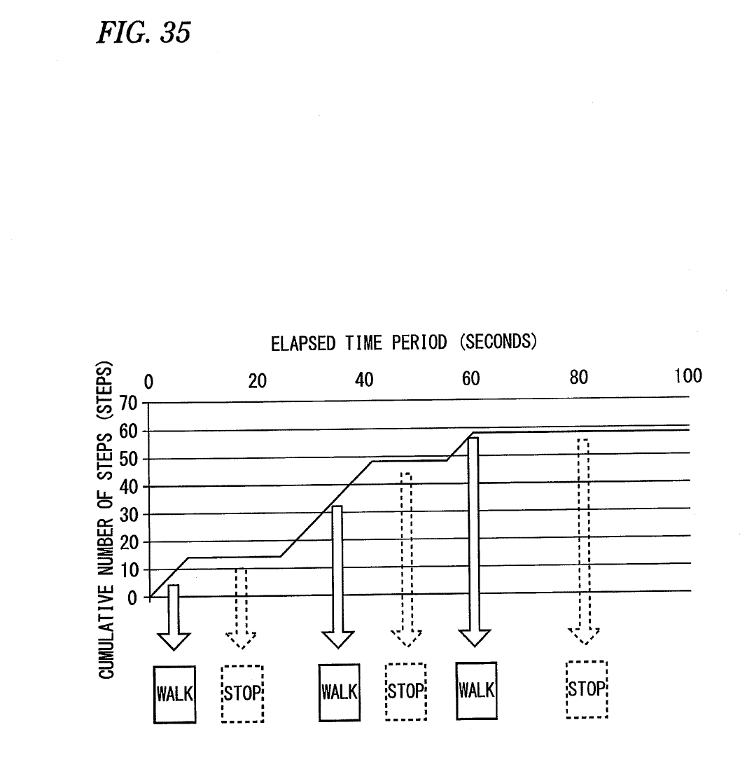

As shown in FIG. 35, by use of an acceleration sensor, it is possible, on the basis of the cumulative number of steps of the worker and the elapsed time period, to specify whether the state is a walking state in which the worker is walking (the number of steps is increasing with a lapse of time) or the state is a stopped state in which the worker is not walking (the number of steps is not increasing with a lapse of time).

For example, a mode of a worker who performs a special activity, such as supplying components from a warehouse to each line, is roughly categorized into two kinds, “carrying of components” and “unloading of components at a warehouse or a line”, each of which can be specified through detection of the walking state by means of an acceleration sensor.

The mode specifying process is started (step ST301 in FIG. 36). The acceleration sensor detects the walking state or the stopped state (step ST302 in FIG. 36). The fourth specification unit 18 specifies a mode in accordance with the detected walking state or stopped state (step ST303 in FIG. 36).

Next, similarly to the embodiments above, the recording unit 13 saves, into the storage, the activity data composed of: the specified mode and the worker, position, and target that have been specified; and the activity time obtained from the timer 10 added thereto (step ST304 in FIG. 36). After the above process, the mode specifying process ends (step ST305 in FIG. 36).

According to embodiment 13 configured as above, similar effects to those in the embodiments above can be exhibited. In addition, mode specification that does not require input by the worker who performs a special activity can be realized.

### Embodiment 14

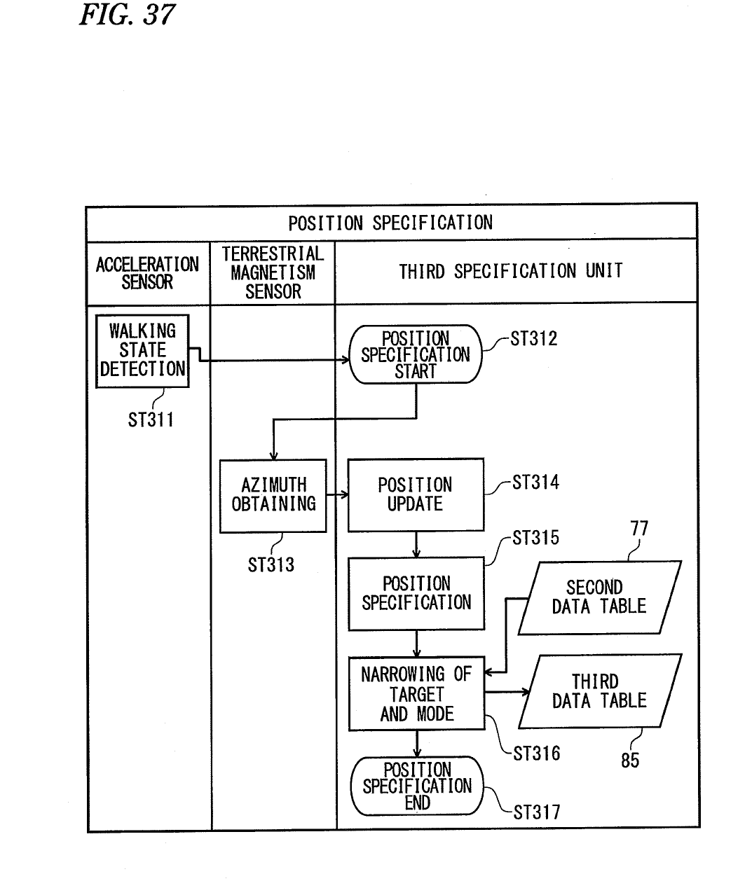

FIG. 37 shows a processing flow used when an acceleration sensor and a terrestrial magnetism sensor are used as the input unit for the second specification unit 16 in an activity recorder of embodiment 14 of the present invention.

As shown in embodiment 13, the walking state of the worker can be detected by use of an acceleration sensor. At this time, the position changes associated with the walking, and thus, the position needs to be updated.

First, the acceleration sensor detects a walking state (step ST311 in FIG. 37). Next, the second specification unit 16 starts position specification (step ST312 in FIG. 37). Then, the terrestrial magnetism sensor obtains the azimuth at which the walking state has been detected (step ST313 in FIG. 37). Accordingly, in which direction and how many steps the worker walked are determined, and thus, the position can be updated (step ST314 in FIG. 37). Next, the second specification unit 16 specifies the position by combining this obtained information and the previous position (step ST315 in FIG. 37).

In accordance with the specified position, the second specification unit 16 narrows the corresponding target and mode on the basis of the first data table 77, and creates the second data table 85 (step ST316 in FIG. 37). After the above process, the position specifying process ends (step ST317 in FIG. 37).

According to embodiment 14 configured as above, it is needless to say that similar effects to those in the embodiments above can be exhibited. In addition, position specification that does not require input by the worker who performs a special activity can be realized.

### Embodiment 15

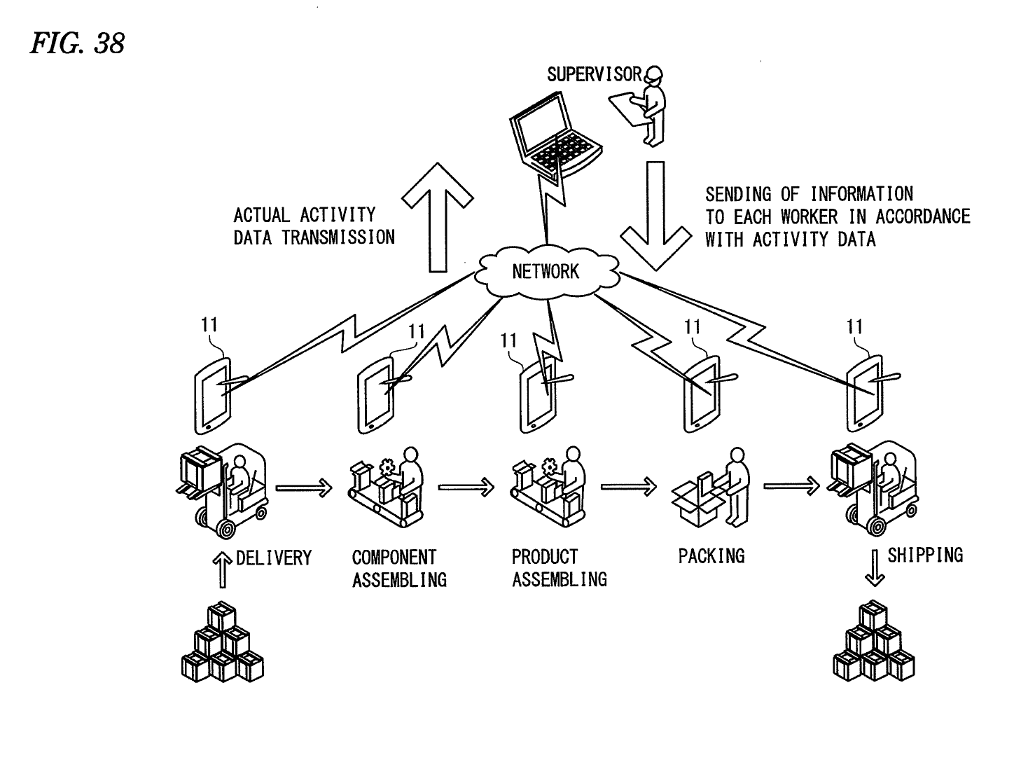

FIG. 38 shows an example in which a communication module is used in an activity recorder of embodiment 15 of the present invention. This activity recorder 11 has a communication module and can transmit and receive a file by the activity recorder 11 being connected to a network.

In FIG. 38, the workers at a series of task steps of delivery, component assembling, product assembling, packing, and shipping each have the activity recorder 11. Then, the activity recorders 11 are connected to the same network. To this network, a terminal owned by the supervisor of the workplace is also connected. Thus, when viewed from one activity recorder 11, each of the other activity recorders 11 and the terminal corresponds to another communication device.

The activity recorder 11 of each worker constantly transmits recorded activity data to the terminal of the supervisor through the network. In response to the received activity data obtained at each step, the supervisor can send individual information to the activity recorder 11 of each worker. For example, the supervisor can instruct a worker who is faster in the task progress than the workers at upstream and downstream steps, to leave his/her task and go and help the workers at such steps in slower progress.

According to embodiment 15 configured as above, it is needless to say that similar effects to those in the embodiments above can be exhibited. In addition, by use of an activity recorder provided with a communication module, the supervisor can grasp in real time the task performance of individual workers, and can contribute to improvement of productivity by individually sending information to workers in accordance with the performance thereof.

It should be noted that, within the scope of the present invention, the respective embodiments may be freely combined with each other, or each of the respective embodiments may be modified or abbreviated as appropriate.

1. to 19. (canceled)

20. An activity recorder for recording, as activity data, an activity of a worker, the activity recorder comprising:
a first specification unit for specifying the worker;
a second specification unit for specifying a position of the worker;
a third specification unit for specifying a target of the worker;
a fourth specification unit for specifying a mode of the worker; and
a relationship database in which relationship data among the worker, the position, the target, and the mode is stored, wherein
at least one of the first specification unit, the second specification unit, and the third specification unit extracts, from the relationship database, the relationship data that corresponds to at least one of the worker, the position, and the target that have been specified, and
at least one of the first specification unit, the second specification unit, the third specification unit, and the fourth specification unit specifies corresponding at least one of the worker, the position, the target, and the mode on the basis of the extracted relationship data.

21. The activity recorder according to claim 20, wherein
a recording unit for recording, as the activity data, the worker, the position, the target, and the mode, with a specified time as an activity time associated therewith, the worker, the position, the target, and the mode having been respectively specified by the first specification unit, the second specification unit, the third specification unit, and the fourth specification unit.

22. The activity recorder according to claim 21, wherein
every time at least one of elements of the worker, the position, the target, and the mode that have been specified changes, the recording unit records, as the activity data, the worker, the position, the target, and the mode, with a specified time added as the activity time.

23. The activity recorder according to claim 21, wherein
the first specification unit specifies the worker on the basis of information from at least one input unit of a touch panel, an IC card reader, a face recognition camera, or a fingerprint recognition sensor.

24. The activity recorder according to claim 21, wherein
the second specification unit specifies the position on the basis of information from an input unit of at least one of a touch panel, a GPS device, a radio field intensity sensor, or an acceleration sensor and a terrestrial magnetism sensor.

25. The activity recorder according to claim 21, wherein
the third specification unit specifies the target on the basis of information from an input unit of at least one of a touch panel, or a sensor for the target.

26. The activity recorder according to claim 21, wherein
the fourth specification unit specifies the mode on the basis of information from an input unit of at least one of a touch panel, a motion capture apparatus, or an acceleration sensor.

27. The activity recorder according to claim 21, comprising a display having a touch panel.

28. The activity recorder according to claim 27, wherein
a task completion button is displayed on the display, and
when the task completion button is pressed, the recording unit records, as the activity data, the worker, the position, the target, and the mode that have been specified, with a time at which a task was completed added as the activity time so as to be associated with the worker, the position, the target, and the mode; calculates an actual task time period on the basis of the activity data; and displays on the display the actual task time period in comparison with a standard task time period set in advance.

29. The activity recorder according to claim 27, wherein
on the display, a suspension button is displayed, and when the suspension button is pressed, a plurality of suspension tasks are displayed as options,
when one of the suspension tasks is selected, the fourth specification unit specifies the selected suspension task as the mode, and
the recording unit records, as the activity data, the worker, the position, and the target that have been specified, with the selected suspension task set as the mode, and with a specified time added as the activity time so as to be associated with the worker, the position, the target, and the mode.

30. The activity recorder according to claim 20, comprising
a communication module for transmitting the activity data to another communication device, and for receiving information transmitted from the other communication device.

31. A non-transitory computer-readable medium having stored thereon an activity recording program for recording, as activity data, an activity of a worker, the activity recording program causing a computer to perform:
a first specification step of specifying a worker;
a second specification step of specifying a position of the worker;
a third specification step of specifying a target of the worker; and
a fourth specification step of specifying a mode of the worker;
wherein
the computer is provided with a relationship database in which relationship data among the worker, the position, the target, and the mode is stored,
in at least one of the first specification step, the second specification step, and the third specification step, the relationship data that corresponds to at least one of the worker, the position, and the target that have been specified is extracted from the relationship database, and
in at least one of the first specification step, the second specification step, the third specification step, and the fourth specification step, corresponding at least one of the worker, the position, the target, and the mode is specified on the basis of the extracted relationship data.

32. The computer-readable medium according to claim 31, wherein
a recording step of recording, as the activity data, the worker, the position, the target, and the mode, with a specified time as an activity time associated therewith, the worker, the position, the target, and the mode having been respectively specified in the first specification step, the second specification step, the third specification step, and the fourth specification step.

33. The computer-readable medium according to claim 32, wherein
in the recording step, every time at least one of elements of the worker, the position, the target, and the mode that have been specified changes, the worker, the position, the target, and the mode, with a specified time added as the activity time, are recorded as the activity data.

34. The computer-readable medium according to claim 32, wherein
to the computer, information from a display having a touch panel is inputted.

35. The computer-readable medium according to claim 34, wherein
a task completion button is displayed on the display, and
in the recording step, when the task completion button is pressed, the worker, the position, the target, and the mode that have been specified, with the time at which a task was completed added as the activity time so as to be associated therewith, are recorded as the activity data; an actual task time period is calculated on the basis of the activity data; and the actual task time period is displayed on the display in comparison with a standard task time period set in advance.

36. The computer-readable medium according to claim 34, wherein
on the display, a suspension button is displayed, and when the suspension button is pressed, a plurality of suspension tasks are displayed as options,
in the fourth specification step, when one of the suspension tasks is selected, the selected suspension task is specified as the mode, and
in the recording step, the worker, the position, and the target that have been specified, with the selected suspension task set as the mode, and with a specified time added as the activity time so as to be associated with the worker, the position, the target, and the mode, are recorded as the activity data.

37. An activity recording method for recording as activity data, an activity of a worker, using
a relationship database in which relationship data among the worker, the position, the target, and the mode is stored, the activity recording method comprising:
a first specification step of specifying a worker;
a second specification step of specifying a position of the worker;
a third specification step of specifying a target of the worker;
a fourth specification step of specifying a mode of the worker; and
a recording step of recording, as the activity data, the worker, the position, the target, and the mode, with a specified time as an activity time associated therewith, the worker, the position, the target, and the mode having been respectively specified in the first specification step, the second specification step, the third specification step, and the fourth specification step,
wherein
in at least one of the first specification step, the second specification step, and the third specification step, the relationship data that corresponds to at least one of the worker, the position, and the target that have been specified is extracted from the relationship database, and
in at least one of the first specification step, the second specification step, the third specification step, and the fourth specification step, corresponding at least one of the worker, the position, the target, and the mode is specified on the basis of the extracted relationship data.

38. The activity recording method according to claim 37, wherein
in the recording step, every time at least one of elements of the worker, the position, the target, and the mode that have been specified changes, the worker, the position, the target, and the mode, with a specified time added as the activity time, are recorded as the activity data.
